(19) United States
(12) Patent Application Publication
(10) Pub. No.: US 2013/0197812 A1
(43) Pub. Date: Aug. 1, 2013

(54) SYSTEMS AND METHODS FOR DETECTION OF CHROMOSOMAL GAINS AND LOSSES

(71) Applicant: PerkinElmer Cellular Technologies Germany GmbH, Tallinn (EE)

(72) Inventor: Kaupo Palo, Viimsi vald (EE)

(73) Assignee: PerkinElmer Cellular Technologies Germany GmbH, Tallinn (EE)

(21) Appl. No.: 13/745,088

(22) Filed: Jan. 18, 2013

Related U.S. Application Data
(60) Provisional application No. 61/589,150, filed on Jan. 20, 2012.

(51) Int. Cl. G06F 19/24

(52) U.S. Cl. CPC G06F 19/24
USPC 702/19

(57) ABSTRACT

A modified principal component analysis technique is described herein for analysis of relatively small data sets for the detection of chromosomal aneuploidies and/or microdeletions. Unlike analysis techniques for microarray studies, the present technique uses a modified principal component analysis that does not involve performing a covariance analysis. The methods, systems, and apparatus described herein allow for significant reduction of data noise in tests for the detection of chromosomal aneuploidies and/or microdeletions, leading to fewer inconclusive results.

### RELATED APPLICATIONS

The present disclosure claims priority to U.S. Provisional Patent 61/589,150, entitled “Systems and Methods for Detection of Chromosomal Gains and Losses,” and filed Jan. 20, 2012, the contents of which are incorporated by reference in its entirety.

### BACKGROUND

The ability to detect genetic abnormalities (e.g., chromosomal aneuploidies and microdeletions) has wide-ranging medical applications, including prenatal testing and cancer diagnostics. Determining the presence of genetic abnormality in a sample requires analyzing detected signals, for example, fluorescence signals. Such signals are often affected by noise. Thus, when processing signal data to determine the presence or absence of a genetic abnormality in a patient sample, it is desirable to use a data analysis method that reduces noise. Existing statistical methods are used to analyze data obtained from genetic detection assays. However, existing statistical methods are often incapable of sufficiently reducing noise in a data set, leading to inconclusive, false positive, and/or false negative results.

Microarray experiments are currently used for genetic testing. In a microarray experiment, the expression of thousands of genes is measured across many conditions. Statistical methods are required to determine the relationship between genes and conditions in a multi-dimensional matrix, thereby reducing the complexity of the data and permitting the ability to distinguish between samples indicative of genetic abnormality and normal samples. One such statistical method that is used is Principal Component Analysis (PCA), which reduces data dimensionality by performing a covariance analysis between factors. This is well-suited for data sets in many dimensions, such as microarray experiments.

Alternatives to microarray experiments have been developed to provide simpler, more focused genetic testing for the most common chromosomal abnormalities. For example, Constitutional BoBs™ is an assay offered by PerkinElmer of Waltham, Mass., that implements BACs-on-Beads™ technology. BACs are Bacterial Artificial Chromosomes that are large cloned sequences of human DNA typically about 170,000 bases long. This particular assay is designed to detect the five most common aneuploidies and gains and losses in nine well characterized target regions of prenatal DNA. The analysis may be performed on as little as 50 ng of genomic DNA extracted directly from amniotic fluid or chorionic villae samples.

The data set in this kind of simpler, more focused genetic testing is much smaller than in the microarray experiments. For example, the Constitutional BoBs™ assay obtains signals from less than 100 beads per patient sample well, run in duplicate, to detect 14 different chromosomal abnormalities as well as gender. Principal Component Analysis (PCA) techniques that perform a covariance analysis would not be appropriate due to the small size of the data set.

A “ratio method” of data analysis can be used for such small data sets. However, it has been found that such methods do not adequately reduce noise, leading to more inconclusive results. Therefore, there is a need for a more accurate and efficient method to analyze data obtained in genetic assays. In particular, there is a need for a method of reducing noise in a data set such that the presence of a chromosomal abnormality can be determined accurately.

### SUMMARY OF THE INVENTION

A modified principal component analysis technique is described herein for analysis of relatively small data sets for the detection of chromosomal aneuploidies and/or microdeletions. For example, even though the Constitutional BoBs™ assay obtains signals from less than 100 beads per patient sample well, it is found that by implementing a modified principal component analysis technique for data analysis that does not involve performing a covariance analysis, it is possible to significantly reduce the noise in such tests, leading to fewer inconclusive results.

As discussed in more detail herein, this improvement is believed to be due, in part, to the nature of tests for the detection of specific aneuploidies and gains and losses in large, well characterized target regions of DNA, where such a target region has a length, for example, in the range of about 20 to 300 kilobases, and each individual attached amplicon comprises a DNA sequence identical to a random portion of the template DNA sequence having a length, for example, in the range of about 500 to 1200 nucleotides, inclusive.

In one aspect, the invention is directed to a method for automated analysis of data from an encoded bead multiplex assay for detection of chromosomal aneuploidies and/or microdeletions, the method comprising the steps of: (a) providing or receiving a set of background-subtracted data corresponding to an encoded bead multiplex assay for a plurality of patient samples run in parallel, wherein the data represents signals detected from beads corresponding to each of a plurality of chromosomal targets for each of a first through n^{th} patient sample, wherein the chromosomal targets are selected for the detection of chromosomal aneuploidies and/or microdeletions; (b) following step (a), normalizing the background-subtracted data from step (a) for each of the first through n^{th} patient samples using a median of signals detected from beads for the corresponding first through n^{th} patient sample, thereby producing normalized data; (c) following step (b), for the normalized data corresponding to each chromosomal target, determine a principal component and for each principal component, determine a corresponding parallel component and an orthogonal component using the normalized data from step (b); (d) following step (c), for each of the first through n^{th} patient sample and for each chromosomal target, identify a deviation from a threshold value indicative of a signal from a normal sample using the corresponding parallel components determined in step (c); and (e) following step (d), for each of the first through n^{th} patient sample and for each chromosomal target, identify at least one quality parameter indicative of sample preparation quality using the corresponding orthogonal components determined in step (c). In certain embodiments, the method further comprises the step of (f) determining one or more chromosomal aneuploidies and/or microdeletions for any one or more of the first through n^{th} patient samples on the basis of the deviations determined in step (d) and the quality parameters determined in step (e). The method may further comprise the step of obtaining the data from the encoded bead multiplex assay.

In certain embodiments, the background-subtracted data in step (a) represents signals detected from 2 to 10 encoded bead types corresponding to each of the chromosomal targets. In certain embodiments, the background-subtracted data in step (a) represents signals detected from at least 2 or at least 4 encoded bead types corresponding to each of the chromosomal targets. In certain embodiments, the background-subtracted data in step (a) represents signals detected from between 4 and 7 (inclusive) encoded bead types corresponding to each of the chromosomal targets.

In certain embodiments, the background-subtracted data in step (a) represents signals detected from encoded beads corresponding to each of at least 3 chromosomal targets for the detection of chromosomal aneuploidies and/or microdeletions. In certain embodiments, the background-subtracted data in step (a) represents signals detected from encoded beads corresponding to each of from 3 to 100 (e.g., from 3 to 50, or from 5 to 25) chromosomal targets for the detection of chromosomal aneuploidies and/or microdeletions.

In certain embodiments, the background-subtracted data in step (a) represents signals detected from a total of from 10 to 1000 encoded beads for each patient sample, not including optional duplicates. In certain embodiments, multiple signals are obtained for each bead, and a median signal is obtained for the bead.

In certain embodiments, the background-subtracted data in step (a) represents signals detected from beads for each of from at least 5 patient samples. In certain embodiments, there are from 5 to 500 patient samples (e.g., from 5 to 300, or from 5 to 100, or from 10 to 50).

In certain embodiments, the plurality of samples run in parallel are run on a single microplate for signal detection. For example, the microplate may be a 96-well microplate.

In certain embodiments, the chromosomal targets are selected for detection of one or more chromosomal aneuploidies, wherein the one or more chromosomal aneuploidies comprise at least one trisomy. In certain embodiments, the chromosomal targets are selected for detection of one or more microdeletions each having length in the range of from 20 to 300 kilobases.

In certain embodiments, step (b) comprises normalizing the background-subtracted data from step (a) for each of the first through n^{th} patient samples using a median of signals detected from beads for the corresponding first through n^{th} patient sample and using a median of medians of signals from the plurality of patient samples run in parallel, thereby producing the normalized data. In certain embodiments, step (b) comprises normalizing the data for a first through m^{th} bead type of the first through n^{th} patient sample using a median of signals detected from the corresponding first through m^{th} bead type of the plurality of patient samples run in parallel. In certain embodiments, step (b) comprises normalizing the background-subtracted data from step (a) for each of the first through n^{th} patient samples using a normalization factor that eliminates bead-to-bead variation, thereby producing double-distilled normalized data.

In certain embodiments, step (c) comprises determining the corresponding parallel component and the orthogonal component using the normalized data for the corresponding chromosomal target for the plurality of patient samples.

In certain embodiments, the deviation identified in step (d) is a median absolute deviation (MAD). In certain embodiments, the deviation identified in step (d) is an interquartile range (IQR).

In certain embodiments, the at least one quality parameter identified in step (e) indicates whether a deviation (e.g., as reflected in a readout based on a multiple {can include a fraction} of threshold value) identified in step (d) is suspicious (false positive). In certain embodiments, the at least one quality parameter for a given patient sample and a given chromosomal target is identified in step (e) using deviations identified in step (d) (e.g., as reflected in readouts based on multiples of threshold values) for other chromosomal targets for the given patient sample, such that multiple anomalies are identified as indicative of poor sample preparation.

In certain embodiments, the chromosomal targets are selected for the detection of chromosomal aneuploidies and/or microdeletions comprising at least one member selected from the group consisting of Williams-Beuren Syndrome, Smith-Magenis Syndrome, Angleman Syndrome, Down Syndrome (Trisomy 21), Edwards Syndrome (Trisomy 18 & X), Patau Syndrome, DiGeorge Syndrome (Velocardio Facial Syndrome), Mille-Dieker Syndrome, Solf-Hirschorn Syndrome, Langer-Giedion Syndrome, Cri-du-chat Syndrome, Prader-Willi Syndrome, 47 XYY Syndrome, and DiGeorge II Syndrome (10p14 microdeletion). In certain embodiments, the chromosomal targets are selected for the detection of all of the above aneuploidies and/or microdeletions.

In certain embodiments, the method further comprises determining a gender for each of the first through n^{th} patient samples by determining a principal component and corresponding parallel component for a Y chromosome target and identifying a deviation from a threshold value (e.g., as reflected in a readout based on a multiple of threshold value) indicative of a signal from a male or female sample using the corresponding parallel component.

In another aspect, the invention is directed to an apparatus for automated analysis of data from an encoded bead multiplex assay for detection of chromosomal aneuploidies and/or microdeletions, the apparatus comprising: a memory for storing a code defining a set of instructions; and a processor for executing the set of instructions, wherein the code comprises an analysis module configured to: (a) provide or receive a set of background-subtracted data corresponding to an encoded bead multiplex assay for a plurality of patient samples run in parallel, wherein the data represents signals detected from beads corresponding to each of a plurality of chromosomal targets for each of a first through n^{th} patient sample, wherein the chromosomal targets are selected for the detection of chromosomal aneuploidies and/or microdeletions; (b) following step (a), normalize the background-subtracted data from step (a) for each of the first through n^{th} patient samples using a median of signals detected from beads for the corresponding first through n^{th} patient sample, thereby producing normalized data; (c) following step (b), for the normalized data corresponding to each chromosomal target, determine a principal component and for each principal component, determine a corresponding parallel component and an orthogonal component using the normalized data from step (b); (d) following step (c), for each of the first through n^{th} patient sample and for each chromosomal target, identify a deviation from a threshold value indicative of a signal from a normal sample using the corresponding parallel components determined in step (c); and (e) following step (d), for each of the first through n^{th} patient sample and for each chromosomal target, identify at least one quality parameter indicative of sample preparation quality using the corresponding orthogonal components determined in step (c).

In one aspect, the invention is directed to a method including accessing, by a processor of a computing device, a set of background-subtracted data corresponding to an encoded bead multiplex assay, where the set of background-subtracted data includes data related to a number of patient samples, the background-subtracted data represents signals detected from beads corresponding to each chromosomal target of a number of chromosomal targets for each patient sample of the number of patient samples, and each chromosomal target of the number of chromosomal targets is identified for the detection of at least one of chromosomal aneuploidies and microdeletions. The method may include, for each patient sample of the number of patient samples, normalizing, by the processor, the background-subtracted data of the respective patient sample to determine normalized data, where normalizing includes determining a median of signals detected from beads of the respective patient sample. The method may include, for each chromosomal target of the number of chromosomal targets, determining, by the processor, a respective principal component of the respective normalized data, and determining, by the processor, a parallel component of the respective principal component. The method may include, for at least a first chromosomal target of the number of chromosomal targets, and for at least a first patient sample of the number of patient samples, using the respective parallel component, identifying, by the processor, one or more signal values within the respective normalized data deviating by at least a threshold value from a normal sample value, where the one or more signal values represent potential genetic abnormality.

In certain embodiments, the method may include, for each chromosomal target of the number of chromosomal targets, and for each patient sample of the number of patient samples, determining an orthogonal component of the respective principal component, and identifying, based at least in part upon the orthogonal component, one or more quality parameters indicative of sample preparation quality.

In certain embodiments, the method may include, for at least the first chromosomal target of the number of chromosomal targets, and for at least the first patient sample of the number of patient samples, identifying a suspected bad sample, where the suspected bad sample is identified based in part upon at least one of the one or more quality parameters indicative of sample preparation quality.

In certain embodiments, the method may include, for at least the first chromosomal target of the number of chromosomal targets, and for at least the first patient sample of the number of patient samples, confirming genetic abnormality in relation to the one or more signal values within the respective normalized data deviating by at least the threshold value from the normal sample value, where confirming genetic abnormality includes confirming the one or more quality parameters are indicative of good sample preparation quality.

In certain embodiments, the method may include, after normalizing the background-subtracted data, renormalizing the background-subtracted data, where renormalizing the background-subtracted data includes determining a median of a first normalized bead signal a for all patients of the number of patients, and, for each patient of the number of patients, normalizing the respective normalized data using the median of the first normalized bead signal a.

In certain embodiments, the method may include, for each patient sample of the number of patients samples, determining a gender of the respective patient, where determining the gender of the respective patient includes identifying, using the respective parallel component, a deviation from a threshold value indicative of a signal from one of a male sample and a female sample.

In certain embodiments, the method may include determining the threshold value, where the threshold value is based upon a mean absolute deviation within the normalized data.

In one aspect, the invention is directed to a system including a processor and a memory, where the memory includes instructions that, when executed by the processor, cause the processor to access a set of background-subtracted data corresponding to an encoded bead multiplex assay, where the set of background-subtracted data includes data related to a number of patient samples, the background-subtracted data represents signals detected from beads corresponding to each chromosomal target of a number of chromosomal targets for each patient sample of the number of patient samples, and each chromosomal target of the number of chromosomal targets is identified for the detection of at least one of chromosomal aneuploidies and microdeletions. The instructions may cause the processor to, for each patient sample of the number of patient samples, normalize the background-subtracted data of the respective patient sample to determine normalized data, where normalizing includes determining a median of signals detected from beads of the respective patient sample. The instructions may cause the processor to, for each chromosomal target of the number of chromosomal targets, determine a respective principal component of the respective normalized data, and determine a parallel component of the respective principal component. The instructions may cause the processor to, for at least a first chromosomal target of the number of chromosomal targets, and for at least a first patient sample of the number of patient samples, using the respective parallel component, identify one or more signal values within the respective normalized data deviating by at least a threshold value from a normal sample value, where the one or more signal values represent potential genetic abnormality.

In one aspect, the invention is directed to a non-transitory computer readable medium having instructions stored thereon, where the instructions, when executed by a processor, cause the processor to access a set of background-subtracted data corresponding to an encoded bead multiplex assay, where the set of background-subtracted data includes data related to a number of patient samples, the background-subtracted data represents signals detected from beads corresponding to each chromosomal target of a number of chromosomal targets for each patient sample of the number of patient samples, and each chromosomal target of the number of chromosomal targets is identified for the detection of at least one of chromosomal aneuploidies and microdeletions. The instructions may cause the processor to, for each patient sample of the number of patient samples, normalize the background-subtracted data of the respective patient sample to determine normalized data, where normalizing includes determining a median of signals detected from beads of the respective patient sample. The instructions may cause the processor to, for each chromosomal target of the number of chromosomal targets, determine a respective principal component of the respective normalized data, and determine a parallel component of the respective principal component. The instructions may cause the processor to, for at least a first chromosomal target of the number of chromosomal targets, and for at least a first patient sample of the number of patient samples, using the respective parallel component, identify one or more signal values within the respective normalized data deviating by at least a threshold value from a normal sample value, where the one or more signal values represent potential genetic abnormality.

The description of elements of the methods above can be applied to this aspect of the invention as well. Furthermore, in another aspect, the invention is directed to a system comprising an encoded bead multiplex assay for detection of chromosomal aneuploidies and/or microdeletions in combination with the apparatus for automated analysis of data from the encoded bead multiplex assay, described above.

### BRIEF DESCRIPTION OF THE DRAWINGS

The objects and features of the invention can be better understood with reference to the drawings described below, and the claims.

FIG. 1 is a block diagram depicting an example system for analyzing the data from the encoded bead multiplex assay.

FIG. 2 is a block diagram depicting an example method for analyzing data from an encoded bead multiplex assay to detect chromosomal aneuploidies and/or microdeletions.

FIG. 3 is a block diagram of an example network environment.

FIG. 4 is a plot of signal intensity (y-axis) of primary signals from 5 beads (x-axis) corresponding to a target, analyzed using modified principal component analysis.

FIG. 5 is a plot for target 21C of signal (red) and quality (green), depicted together with threshold boundaries.

FIG. 6 is a plot of signal intensity (y-axis) of primary signals from beads (x-axis) corresponding to a target, analyzed using modified principal component analysis.

FIG. 7 shows assay results calculated by the ratio algorithm for Sample 1 (WBS, Williams-Beuren Syndrome).

FIG. 8 shows the assay results for Sample 1 (WBS, Williams-Beuren Syndrome). analyzed using the exemplary method embodied by the pseudocode described herein.

FIG. 9 shows assay results calculated by the ratio algorithm for Sample 2 (SMS, Smith-Magenis Syndrome).

FIG. 10 shows the assay results for Sample 2 (SMS, Smith-Magenis Syndrome). analyzed using the exemplary method embodied by the pseudocode described herein.

FIG. 11 shows assay results calculated by the ratio algorithm for Sample 3 (AS, Angleman Syndrome).

FIG. 12 shows the assay results for Sample 3 (AS, Angleman Syndrome) analyzed using the exemplary method embodied by the pseudocode described herein.

FIG. 13 shows assay results calculated by the ratio algorithm for Sample 4 (Trisomy 21).

FIG. 14 shows the assay results for Sample 4 (Trisomy 21) analyzed using the exemplary method embodied by the pseudocode described herein.

FIG. 15 shows assay results calculated by the ratio algorithm for Sample 5 (Trisomy 18 and Trisomy X).

FIG. 16 shows the assay results for Sample 5 (Trisomy 18 and Trisomy X) analyzed using the exemplary method embodied by the pseudocode described herein.

FIG. 17 shows assay results calculated by the ratio algorithm for Sample 6 (Trisomy 13).

FIG. 18 shows the assay results for Sample 6 (Trisomy 13) analyzed using the exemplary method embodied by the pseudocode described herein.

FIG. 19 shows assay results calculated by the ratio algorithm for Sample 7 (DiGeorge 22q).

FIG. 20 shows the assay results Sample 7 (DiGeorge 22q) analyzed using the exemplary method embodied by the pseudocode described herein.

FIG. 21 shows assay results calculated by the ratio algorithm for Sample 8 (Miller Dieker Syndrome).

FIG. 22 shows the assay results for Sample 8 (Miller Dieker Syndrome) analyzed using the exemplary method embodied by the pseudocode described herein.

FIG. 23 shows assay results calculated by the ratio algorithm for Sample 9 (Wolf-Hirschhorn Syndrome).

FIG. 24 shows the assay results for Sample 9 (Wolf-Hirschhorn Syndrome) analyzed using the exemplary method embodied by the pseudocode described herein.

FIG. 25 shows assay results calculated by the ratio algorithm for Sample 10 (Langer-Giedion Syndrome).

FIG. 26 shows the assay results for Sample 10 (Langer-Giedion Syndrome) analyzed using the exemplary method embodied by the pseudocode described herein.

FIG. 27 shows assay results calculated by the ratio algorithm for Sample 11 (Cri-du-chat Syndrome).

FIG. 28 shows the assay results for Sample 11 (Cri-du-chat Syndrome) analyzed using the exemplary method embodied by the pseudocode described herein.

FIG. 29 shows assay results calculated by the ratio algorithm for Sample 12 (Prader-Willi Syndrome).

FIG. 30 shows the assay results for Sample 12 (Prader-Willi Syndrome) analyzed using the exemplary method embodied by the pseudocode described herein.

FIG. 31 shows assay results calculated by the ratio algorithm for Sample 13 (Disomy Y; XYY).

FIG. 32 shows the assay results for Sample 13 (Disomy Y; XYY) analyzed using the exemplary method embodied by the pseudocode described herein.

FIG. 33 shows assay results calculated by the ratio algorithm for Sample 14 (DiGeorge 10p14).

FIG. 34 shows the assay results for Sample 14 (DiGeorge 10p14) analyzed using the exemplary method embodied by the pseudocode described herein.

FIG. 35 illustrates an example computing device and an example mobile computing device.

### DESCRIPTION

It is contemplated that apparatus, systems, methods, and processes of the present disclosure encompass variations and adaptations developed using information from the embodiments described herein. Adaptation and/or modification of the apparatus, systems, methods, and processes described herein may be performed by those of ordinary skill in the relevant art.

Throughout the description, where systems are described as having, including, or comprising specific components, or where processes and methods are described as having, including, or comprising specific steps, it is contemplated that, additionally, there are systems of the present disclosure that consist essentially of, or consist of, the recited components, and that there are processes and methods according to the present disclosure that consist essentially of, or consist of, the recited processing steps.

It should be understood that the order of steps or order for performing certain actions is immaterial so long as the process remains operable. Moreover, two or more steps or actions may be conducted simultaneously.

The mention herein of any publication, for example, in the Background section, is not an admission that the publication serves as prior art with respect to any of the claims presented herein. The Background section is presented for purposes of clarity and is not meant as a description of prior art with respect to any claim.

Subject headers are provided herein for convenience only. They are not intended to limit the scope of embodiments described herein.

As used herein, “median” is considered to encompass the traditional concepts of either median or mean. For example, either a traditional median or a traditional mean can be used, and both are considered to fall within the meaning of “median” as used herein.

The present disclosure relates to methods and systems for analyzing data corresponding to each of a number of chromosomal targets, from a number of patient samples run in parallel. In some embodiments, the methods described herein can be used to analyze data from an encoded bead multiplex assay for detecting chromosomal aneuploidies and/or microdeletions. Encoded bead multiplex assays are described in detail in U.S. Pat. No. 7,932,037. Briefly, an encoded bead multiplex assay refers to a method of assaying a DNA sample using a number of encoded particles having attached amplicons (also referred to herein as “probes”) amplified from a template DNA sequence. The amplicons include a nucleic acid sequence complementary to a portion of a template genomic nucleic acid. (e.g., representative of a chromosome or a microdeletion).

In certain embodiments, each particle of a particle set is encoded with the same code such that each particle of a particle set is distinguishable from each particle of another particle set. The code of a particle indicates the identity of the attached amplicon. A particle may be encoded, for example, using optical, chemical, physical or electronic tags. In some embodiments, fluorescent tags emitting different wavelengths are used to encode different particle sets.

Amplicons of the encoded particle sets are hybridized with detectably labeled sample DNA and, optionally, with detectably labeled reference DNA. A set of signals are detected which are indicative of specific hybridization of the amplicons of one or more encoded bead sets with detectably labeled sample and/or reference DNA. Methods of signal detection will depend upon the particular type of label used.

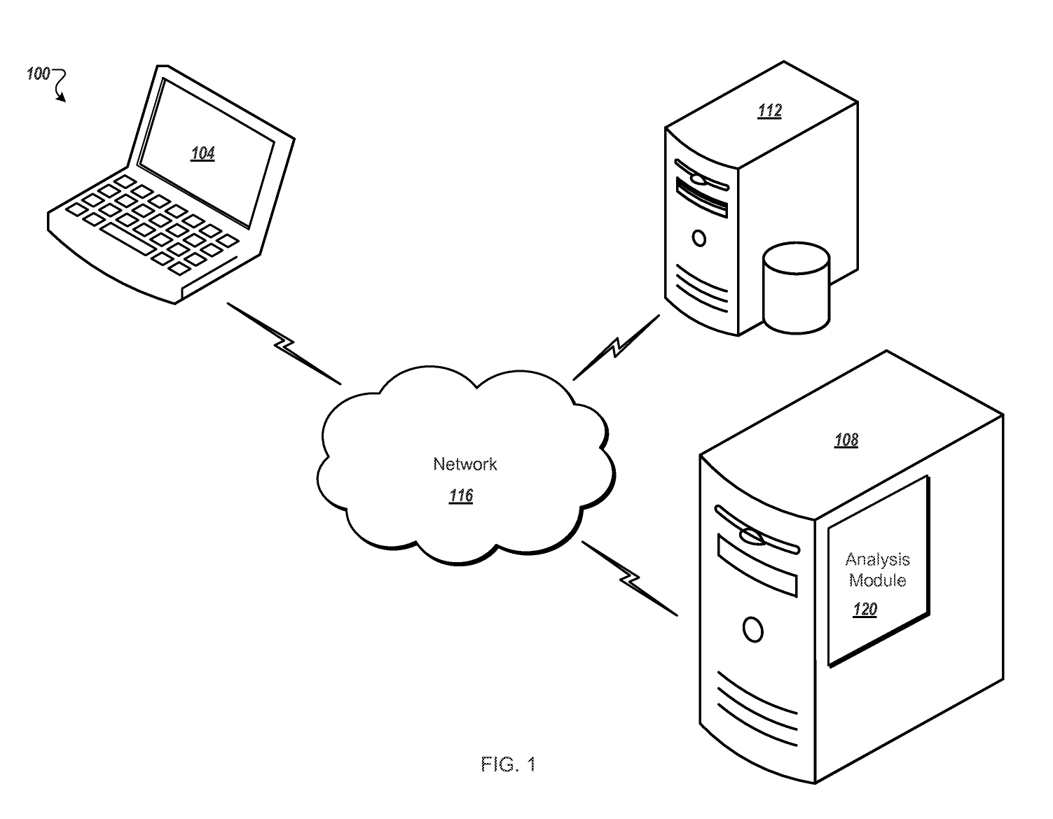

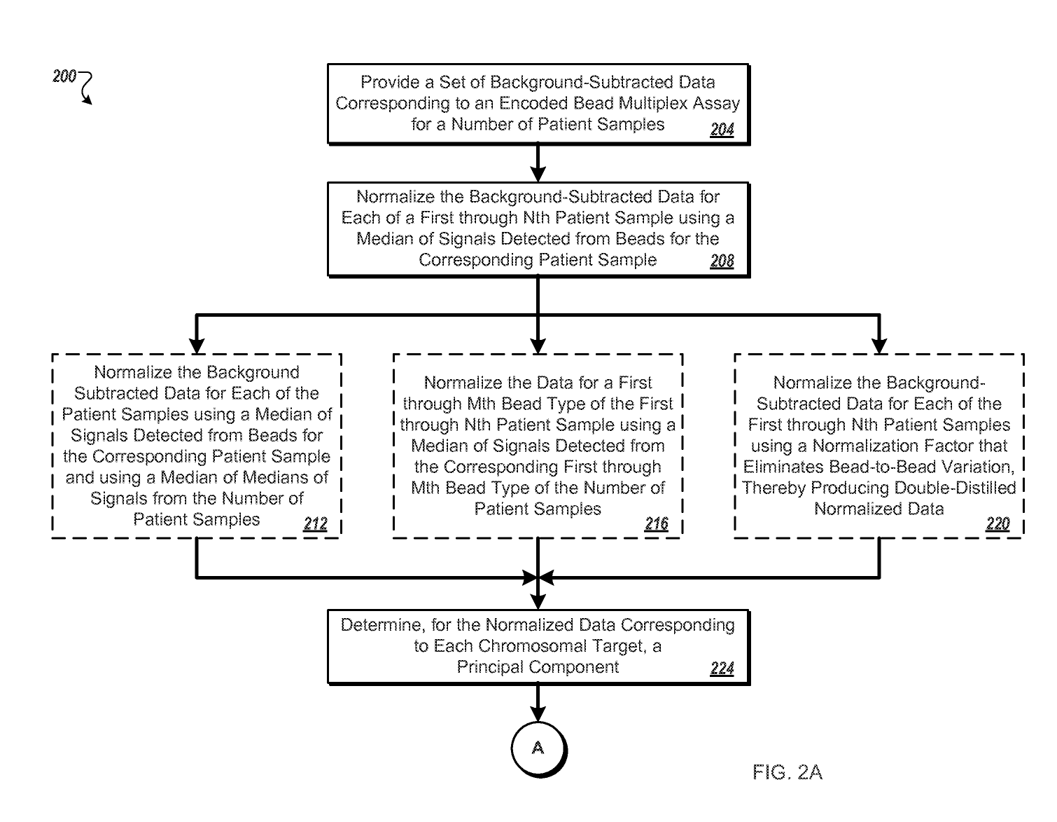

FIG. 1 depicts an example system 100 for analyzing the data from the encoded bead multiplex assay. The system 100 includes a client node 104, a server node 108, a database 112, and, for enabling communications therebetween, a network 116. As illustrated, the server node 108 may include an analysis module 120.

The network 116 may be, for example, a local-area network (LAN), such as a company or laboratory Intranet, a metropolitan area network (MAN), or a wide area network (WAN), such as the Internet. Each of the client node 104, server node 108, and database 112 may be connected to the network 116 through a variety of connections including, but not limited to, standard telephone lines, LAN or WAN links (e.g., T1, T3, 56 kb, X.25), broadband connections (e.g., ISDN, Frame Relay, ATM), or wireless connections. The connections, moreover, may be established using a variety of communication protocols (e.g., HTTP, TCP/IP, IPX, SPX, NetBIOS, NetBEUI, SMB, Ethernet, ARCNET, Fiber Distributed Data Interface (FDDI), RS232, IEEE 802.11, IEEE 802.11a, IEEE 802.11b, IEEE 802.11g, and direct asynchronous connections).

The client node 104 may be any type of personal computer, Windows-based terminal, network computer, wireless device, information appliance, RISC Power PC, X-device, workstation, mini computer, main frame computer, personal digital assistant, set top box, handheld device, or other computing device that is capable of both presenting information/data to, and receiving commands from, a user of the client node 104 (e.g., a laboratory technician). The client node 104 may include, for example, a visual display device (e.g., a computer monitor), a data entry device (e.g., a keyboard), persistent and/or volatile storage (e.g., computer memory), a processor, and a mouse. In some embodiments, the client node 104 includes a web browser, such as, for example, the INTERNET EXPLORER program developed by Microsoft Corporation of Redmond, Wash., to connect to the World Wide Web.

For its part, the server node 108 may be any computing device that is capable of receiving information/data from and delivering information/data to the client node 104, for example over the network 116, and that is capable of querying, receiving information/data from, and delivering information/data to the database 112. For example, as further explained below, the server node 108 may query the database 112 for a set of background-subtracted data, receive the data therefrom, process and analyze the data, and then present one or more results of the analysis to the user at the client node 104. The set of background-subtracted data may correspond, for example, to an encoded bead multiplex assay for a set of patient samples run in parallel. The server node 108 may include a processor and persistent and/or volatile storage, such as computer memory.

The database 112 may be any repository of information (e.g., a computing device or an information store) that is capable of (i) storing and managing collections of data, such as the background-subtracted data, (ii) receiving commands/queries and/or information/data from the server node 108 and/or the client node 104, and (iii) delivering information/data to the server node 108 and/or the client node 104. For example, the database 112 can be any information store storing the files output by an instrument used in a laboratory, whether that be a computer memory onboard the instrument itself or a separate information store to which the output files of the instrument have been transferred. The database 112 may communicate using SQL or another language, or may use other techniques to store, receive, and transmit data.

The analysis module 120 of the server node 108 may be implemented as any software program and/or hardware device, for example an application specific integrated circuit (ASIC) or a field programmable gate array (FPGA), that is capable of providing the functionality described below. It will be understood by one having ordinary skill in the art, however, that the illustrated analysis module 120, and the organization of the server node 108, are conceptual, rather than explicit, requirements. For example, the single analysis module 120 may in fact be implemented as multiple modules, such that the functions performed by the single module, as described below, are in fact performed by the multiple modules.

Although not shown in FIG. 1, each of the client node 104, the server node 108, and the database 112 may also include its own transceiver (or separate receiver and transmitter) that is capable of receiving and transmitting communications, including requests, responses, and commands, such as, for example, inter-processor communications and networked communications. The transceivers (or separate receivers and transmitters) may each be implemented as a hardware device, or as a software module with a hardware interface.

It will also be understood by those skilled in the art that FIG. 1 is a simplified illustration of the system 100 and that it is depicted as such to facilitate the explanation of the illustrative embodiments. Moreover, the system 100 may be modified in a variety of manners without departing from the spirit and scope of the present disclosure. For example, the server node 108 and/or the database 112 may be local to the client node 104 (such that they may all communicate directly without using the network 116), or the functionality of the server node 108 and/or the database 112 may be implemented on the client node 104 itself (e.g., the analysis module 120 and/or the database 112 may reside on the client node 104 itself). As such, the depiction of the system 100 in FIG. 1 is non-limiting.

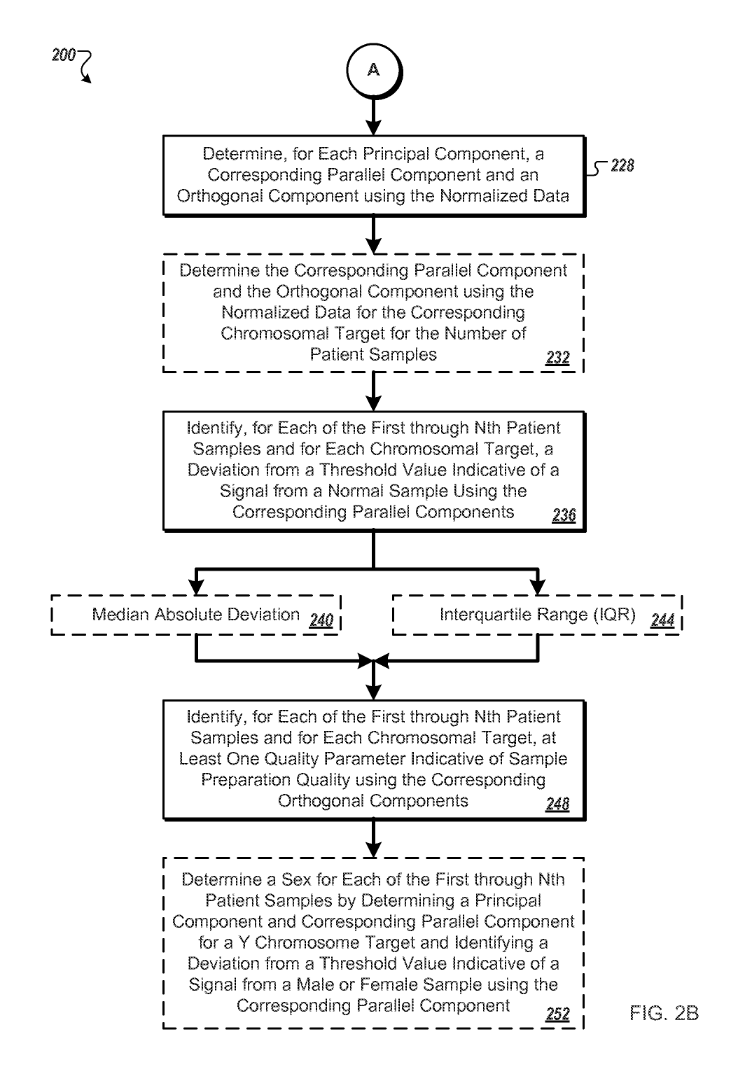

FIG. 2 illustrates an example method 200 for analyzing data from an encoded bead multiplex assay to detect chromosomal aneuploidies and/or microdeletions. The method 200 may be performed, for example by using the system 100 of FIG. 1. The analysis module 120 of FIG. 1, for example, may perform at least a portion of the method 200.

In some embodiments, the method 200 begins with accessing a set of background-subtracted data corresponding to an encoded bead multiplex assay for a set of patient samples run in parallel (204). In some examples, the set of background-subtracted data may be provided by (or received by) the analysis module 120 of FIG. 1. The data may represent signals detected from beads corresponding to each of a number of chromosomal targets for each of a first through n^{th} patient sample, while the chromosomal targets may be selected for the detection of chromosomal aneuploidies and/or microdeletions. Background subtraction, for example, may relate to subtracting values of control bead signals (e.g., average values of fluorescent signals, closest background measurement to median value across all patients, etc.) from signals corresponding to the patient samples. The control beads can be, for example, beads displaying non-target DNA sequences, such as random DNA sequences, non-human DNA sequences and the like, in order to correct for non-specific binding of sample components to the beads.

The background-subtracted data may be derived from an encoded bead multiplex assay, where bead signals correspond to specific patient samples. In an exemplary embodiment, data corresponding to an encoded bead multiplex assay is presented as a table of median values of primary readouts (bead signals) with background counts subtracted. The assay may be, for example, an assay using amplicon probes as described in U.S. Pat. No. 7,932,037 (Adler et al.), which is incorporated herein by reference in its entirety. There may be multiple bead signals per chromosomal target, each of which may be indicative of a different part of the chromosomal target sequence (e.g., there may be from 2 to 10, or from 4 to 7 beads per target), and there may be multiple chromosomal targets tested for each patient sample. In some embodiments in which testing occurs in a microplate, each well of the microplate contains beads (e.g., from 20 to 1000 beads per well) for the testing of each patient sample. There may be duplicate wells (or triplicate), for example, for each patient sample, each containing the full complement of beads. For example, the encoded bead multiplex assay may be the Constitutional BoBs™ assay offered by PerkinElmer of Waltham, Mass., which implements BACs-on-Beads™ technology. BACs are Bacterial Artificial Chromosomes, which are large cloned sequences of human DNA typically about 170,000 bases long.

The particles used in the bead analysis, for example, can include organic or inorganic particles, such as glass or metal and can be particles of a synthetic or naturally occurring polymer, such as polystyrene, polycarbonate, silicon, nylon, cellulose, agarose, dextran, and polyacrylamide. Particles may be latex beads. The particles may be microparticles or nanoparticles (e.g., particles with a diameter of less than one millimeter).

The particles used in bead analysis may include functional groups for binding to amplicons. For example, particles can include carboxyl, amine, amino, carboxylate, halide, ester, alcohol, carbamide, aldehyde, chloromethyl, sulfur oxide, nitrogen oxide, epoxy and/or tosyl functional groups. Binding amplicons to the particles results in encoded particles.

Encoded particles are particles which are distinguishable from other particles based on a characteristic illustratively including an optical property such as color, reflective index and/or an imprinted or otherwise optically detectable pattern. For example, the particles may be encoded using optical, chemical, physical, or electronic tags. Encoded particles can contain or be attached to, one or more fluorophores which are distinguishable, for instance, by excitation and/or emission wavelength, emission intensity, excited state lifetime or a combination of these or other optical characteristics. Optical bar codes can be used to encode particles.

In particular embodiments, each particle of a particle set is encoded with the same code such that each particle of a particle set is distinguishable from each particle of another particle set. In further embodiments, two or more codes can be used for a single particle set. Each particle can include a unique code, for example. In certain embodiments, particle encoding includes a code other than or in addition to, association of a particle and a nucleic acid probe specific for genomic DNA.

In particular embodiments, the code is embedded, for example, within the interior of the particle, or otherwise attached to the particle in a manner that is stable through hybridization and analysis. The code can be provided by any detectable means, such as by holographic encoding, by a fluorescence property, color, shape, size, light emission, quantum dot emission and the like to identify particle and thus the capture probes immobilized thereto. In some embodiments, the code is other than one provided by a nucleic acid.

A method of assaying genomic DNA includes providing encoded particles having attached amplicons which together represent substantially an entire template genomic nucleic acid. In particular embodiments, encoded particles having attached amplicons are provided which together represent more than one copy of substantially an entire template genomic nucleic acid.

A sample of genomic DNA to be assayed for genomic gain and/or loss is labeled with a detectable label. Reference DNA is also labeled with a detectable label for comparison to the sample DNA. The sample and reference DNA can be labeled with the same or different detectable labels depending on the assay configuration used. For example, sample and reference DNA labeled with different detectable labels can be used together in the same container for hybridization with amplicons attached to encoded particles in particular embodiments. In further embodiments, sample and reference DNA labeled with the same detectable labels can be used in separate containers for hybridization with amplicons attached to particles.

The term “detectable label” refers to any atom or moiety that can provide a detectable signal and which can be attached to a nucleic acid. Examples of such detectable labels include fluorescent moieties, chemiluminescent moieties, bioluminescent moieties, ligands, magnetic particles, enzymes, enzyme substrates, radioisotopes and chromophores.

Data may be obtained through detection of a first signal indicating specific hybridization of the attached DNA sequences with detectably labeled genomic DNA of an individual subject and detection of a second signal indicating specific hybridization of the attached DNA sequences with detectably labeled reference genomic DNA. Any appropriate method, illustratively including spectroscopic, optical, photochemical, biochemical, enzymatic, electrical and/or immunochemical is used to detect the detectable labels of the sample and reference DNA hybridized to amplicons bound to the encoded particles.

Signals that are indicative of the extent of hybridization can be detected, for each particle, by evaluating signal from one or more detectable labels. Particles are typically evaluated individually. For example, the particles can be passed through a flow cytometer. In addition to flow cytometry, a centrifuge may be used as the instrument to separate and classify the particles. In addition to flow cytometry and centrifugation, a free-flow electrophoresis apparatus may be used as the instrument to separate and classify the particles.

A first signal is detected indicating specific hybridization of the encoded particle attached DNA sequences with detectably labeled genomic DNA of an individual subject. A second signal is also detected indicating specific hybridization of the encoded particle attached DNA sequences with detectably labeled reference genomic DNA. The first signal and the second signal are compared, yielding information about the genomic DNA of the individual subject compared to the reference genomic DNA.

To aid in presentation of example mathematical formulas related to the method 200, within a table of data derived from an encoded bead multiplex assay, each column of the table of bead signals corresponds to a specific patient sample (e.g., indexed by capital Latin letters A, B, C, etc., used as subscripts), and each row of the table corresponds to specific bead signals (e.g., indexed by Greek letters α, β, γ, etc., used as subscripts). The signal rows may be grouped by chromosomal target group (e.g., indexed by minuscule Latin letters i, j, k, etc., used as superscripts).

As defined above, a specific data element of the data table is represented as:

D_{Aα} (1)

which is the background-subtracted bead signal corresponding to patient A and bead a. In specific chromosomal target group i context, if the target index i is present, the index a ranges only within this target:

Dⁱ_{Aα} (2)

A goal of the method 200 is to reduce the data to specific readouts (R) per patient (A) and per target (i), Rⁱ_{A}, to define threshold parameter (T) per target (i), Tⁱ, and to provide quality measures (QX) of each patient sample (A), QX_{A}.

In some embodiments, the background-subtracted data is normalized for each of a first through n^{th} patient sample (204). Because of variations in sample preparations and other sources of systematic noise, it is desirable to normalize data before further processing. It is not recommended to use provided totals because they are not robust against outliers. For example, if a patient has a chromosomal anomaly, then the normalized value will be biased in a statistically unfavorable direction. The analysis module 120 of FIG. 1 may normalize the background-subtracted data for each of the first through n^{th} patient samples using a median of signals detected from beads for the corresponding first through n^{th} patient sample.

In some implementations, normalizing the background-subtracted data may involve one or more of steps 212 through 220, as follows. The functionality described in steps 212 through 220, for example, may be performed by the analysis module 120. In some embodiments, the background-subtracted data may be normalized for each of the first through n^{th} patient samples using a median of signals detected from beads for the corresponding first through n^{th} patient sample and using a median of medians of signals from the set of patient samples run in parallel (212). In this normalization option, the column-wise median values (median of all readouts collected from a particular sample) may be adjusted to be the same. Thus, a first normalized bead signal, N¹_{Aα} for patient A and bead a (superscript 1 does not refer to target) is the data element D_{Aα} scaled by F/F_{A}, such that:

$$\begin{matrix}{N}_{Aa}^{1} = {D}_{Aa} \frac{F}{{F}_{A}} \\ where & ( 3 ) \\ {F}_{A} = {median}_{a} ( {D}_{Aa} ) & ( 4 )\end{matrix}$$

and is calculated for each patient by taking the median value taken over all bead signals for a given patient (denoted by subscript of the median function), and

F=median_{A}(F_{A}) (5)

The background-subtracted data, in some embodiments, may be normalized for a first through m^{th} bead type of the first through n^{th} patient sample using a median of signals detected from the corresponding first through m^{th} bead type of the set of patient samples run in parallel (216). Further to the example presented above in relation to step 212, the background-subtracted data set may be normalized by F.

In some embodiments, the background-subtracted data may be normalized for each of the first through n^{th} patient samples using a normalization factor that eliminates bead-to-bead variation, thereby producing double-distilled normalized data (220). Double-distilled normalized data, for example, may be used to improve noise reduction. Because different elementary signals are of different amplitude, then the median used for normalization is contributed to mainly by targets that have close to median signal. It is beneficial to temporarily eliminate bead-to-bead variation and renormalize the data. It has been observed that an additional twenty percent reduction of noise can be achieved by performing this step.

First, create a temporary normalized array:

$$\begin{matrix}{N}_{Aa}^{2} = {N}_{Aa}^{1} \frac{1}{{F}_{a}} \\ where & ( 6 ) \\ {F}_{A} = {median}_{a} ( {N}_{Aa}^{1} ) & ( 7 )\end{matrix}$$

Thus, individual values of N¹_{Ac}, are re-normalized for bead a with the median of all patients' normalized N¹'s for bead α. The effect of the procedure is that each signal N²_{Aα} is at the same level (equal median over A). Now, feed N²_{Aα} back into equations (3) through (5) (e.g., as described in relation to step 212). In other words, compute the following:

N³_{Aα}=N²_{Aα}*F′/F′_{A} (8)

where

F′_{A}=median(N²_{Aα}) (9)

F′=median(F′_{A}) (10)

Then, re-normalize the output, N³_{Aα}, back to initial levels:

N_{Aα}=N²_{Aα}F_{α} (11)

Any combination of normalization techniques 212, 216, and 220 may be used. In other embodiments, additional normalization techniques may be used in lieu of or in addition to the described techniques.

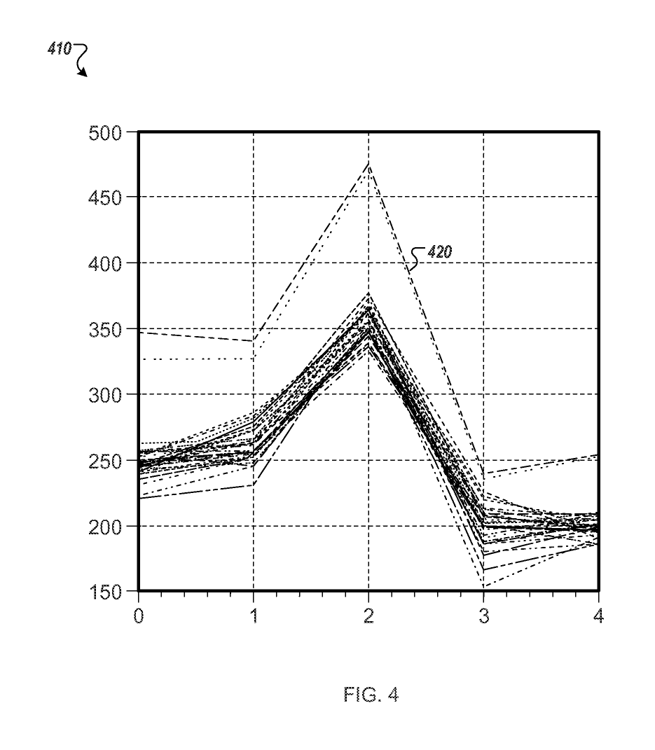

Once the background subtracted data has been normalized in step 208 (and, optionally, one or more of steps 212, 216, and 220), in some embodiments, a principal component is determined for the normalized data corresponding to each chromosomal target (224). In the following example technique, no covariance matrix is used. The principal component of a particular chromosomal target may be represented by the characteristic curve shape of a plot of the signals from the beads corresponding to that target. For example, FIG. 4 shows a plot 410 of the signal intensity (y-axis) of five primary signals from five beads (x-axis) corresponding to an example target. Each curve corresponds to a different patient sample, A. Each of the five beads shown (x-axis), corresponds to a different part of the chromosomal target sequence. It is an empirical observation that curve shapes are generally stable over samples and generally only the amplitude varies. In other words, the principal component coincides with the “average shape”. This is useful, because principal component analysis based on covariant matrix is not robust for a limited size data set that has outliers. “Average shape”, on the other hand, can be robustly estimated as median shape. FIG. 4, which shows a given target 13C (probe associated with Trisomy 13, Patau Syndrome), has one patient sample (curve 420) that exhibits an abnormal signal (e.g., due to genetic anomaly).

For each target, in a particular example, the principal component may be determined as follows:

$$\begin{matrix}{P}_{Aa}^{i} = \frac{{N}_{a}^{i}}{{N}^{i}} \\ where & ( 12 ) \\ {N}_{a}^{i} = {median}_{A} ( {N}_{Aa}^{i} ) & ( 13 )\end{matrix}$$

and where the normalization factor N′ is the length of the vector calculated as square root of the scalar product as follows:

Nⁱ=\sqrt{(\vec{N}ⁱ ,\vec{N}ⁱ)}≡\sqrt{Σ_{α}Nⁱ_{α}Nⁱ_{α}} (14)

Thus, Pⁱ_{α} is a unit length vector:

(Pⁱ,Pⁱ)≡Σ_{α}Pⁱ_{α}Pⁱ_{α}=1 (15)

Turning to FIG. 2B, in some embodiments, a parallel component and an orthogonal corresponding to each principal component may be determined using the normalized data (228). In some implementations, determining the corresponding parallel component and the corresponding orthogonal component involves using the normalized data for the corresponding chromosomal target for the set of patient samples (232). The target signal (a vector of primary signals), for example, may be decomposed into parallel and orthogonal components. The amplitude (length) of the parallel component (readout) is the readout per target we are looking for and the amplitude of the orthogonal component is determinative of whether the curve is of normal shape pattern (quality).

In a particular embodiment, the amplitude of the parallel component (readout) is calculated as a projection onto the principal component:

Rⁱ_{A}=(Pⁱ,Nⁱ_{A})=Σ_{α}Pⁱ_{α}Nⁱ_{Aα} (16)

The amplitude of the orthogonal component is calculated from the Pythagorean theorem:

Qⁱ_{A}={square root over ((Nⁱ_{A},Nⁱ_{A})=(Rⁱ_{A}²)}=\sqrt{τ_{α}Nⁱ_{Aα}Nⁱ_{Aα}=(Rⁱ_{A})²} (17)

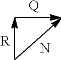

Thus, from the principal component analysis, it is possible to reduce the normalized primary signals into readout and quality parameters:

Nⁱ_{Aα}→{Rⁱ_{A},Qⁱ_{A}} (18)

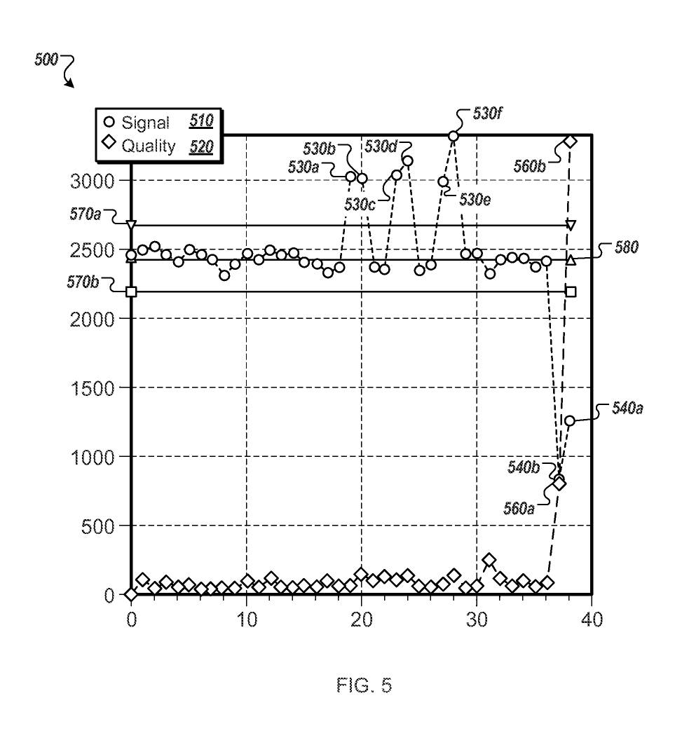

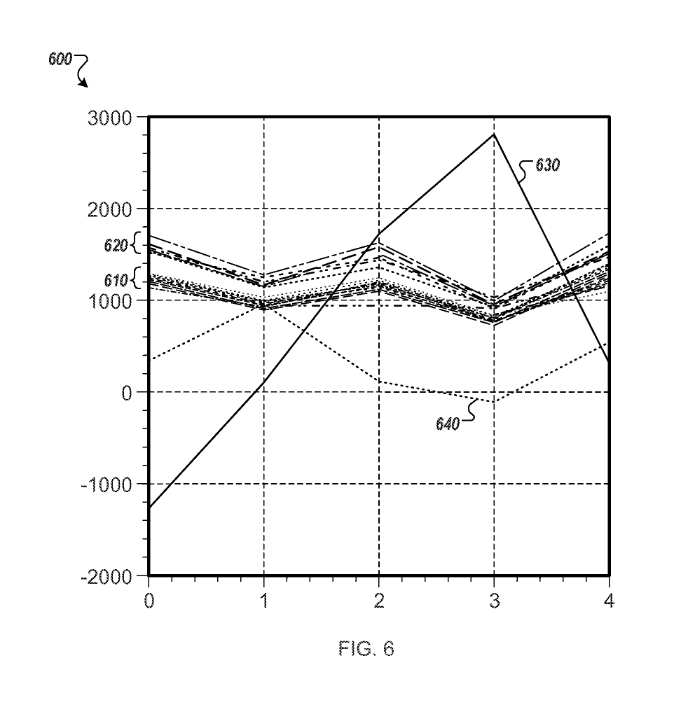

In illustration, FIG. 5 is a plot of a normalized primary signal for a given target 21C (probe associated with Trisomy 21, Down Syndrome). The plot shows both a readout signal component 510 and a quality component 520 of the primary signal. The signal and quality components 510, 520 of FIG. 5 are depicted together with threshold boundaries 570 drawn, where threshold is determined in the following section (e.g., in relation to step 236). The peaks 530 in the middle of the plot correspond to genetic anomalies. The corresponding quality parameters are at a normal level. The rightmost outliers 540, however, cannot be associated with genetic anomalies because their quality parameters 560 are also abnormally high (22 and 106 standard deviations, respectively). A line 580 corresponds to a “normal” readout signal (e.g., no genetic anomalies). This is alternatively depicted in a graph 600 of FIG. 6, which shows primary signal plots. Turning to FIG. 6, most of the samples form a bundle of curves 610. Above the bundle of curves 610 is a group of curves 620 (corresponding to patient samples) with the same shape pattern but with higher amplitude. The group of curves 620 corresponds to chromosomal abnormalities. The two irregular samples (references 630 and 640) have very different curve shape and are well distinguished from the other samples. The samples corresponding to irregular curves 630 and 640 may be considered to have an indeterminate result due to a large corresponding quality value.

Returning to FIG. 2, in some embodiments, for each of the first through n^{th} patient sample and for each chromosomal target, a deviation from a threshold value indicative of a signal from a normal sample is identified using the corresponding parallel components (236). The absolute values of the readout and quality parameters are essentially random quantities and no decision can be made without setting threshold values on what is considered to be a normal signal. Standard deviation would be a possible choice as measure of deviation from normal. However, preferably, a more robust calculation of threshold values is used, for example, median absolute deviation (MAD) or interquartile range (IQR).

In some embodiments, the deviation from the threshold value is a median absolute deviation (MAD) (240). An equation for mean absolute deviation follows:

MAD(x)=1.4826 median(|x− x̅|) (19)

where x̅ denotes median value of a random variable x. A normalization factor may be chosen such that for a normally distributed quantity, MAD will be a numeric estimator of standard deviation.

The threshold parameter is now determined as follows:

Tⁱ=MAD_{A}(Rⁱ_{A}) (20)

The selected threshold level that is usable depends on further evaluations, e.g., there is a risk balance to consider either in favor of false positives or false negatives. Observations for the Constitutional BoBs™ assay, for example, indicate that 3T′ (3 sigma) or larger is a suitable choice.

It is now possible to rescale the readouts as multiples (e.g., fraction) of threshold value, as follows:

$$\begin{matrix}{\breve{R}}_{A}^{i} = \frac{{R}_{A}^{i} - {R}^{i}}{{T}^{i}} \\ where & ( 21 ) \\ {R}^{i} = {median}_{A} ( {R}_{A}^{i} ) & ( 22 )\end{matrix}$$

In other embodiments, the deviation from the threshold value is an interquartile range (IQR) (244). The interquartile range (IQR) is calculated as follows:

$$IQR ( x ) = \frac{quantile ( 0.75 , x ) - quantile ( 0.25 , x )}{1.349} \qquad ( 23 )$$

The normalization factor may be chosen for IQR to coincide with standard deviation in cases where x is normally distributed. Upon determining the IQR, the threshold parameter may be determined similarly to the threshold determined based upon MAD, as illustrated in equation (20).

In some embodiments, for each of the first through n^{th} patient sample and for each chromosomal target, at least one quality parameter indicative of sample preparation quality is identified (248). The at least one quality parameter, for example, may be identified using the corresponding orthogonal components. It may be expected that if the quality parameter Qⁱ_{A} is abnormally high (e.g., outside 3T), this would indicate the gene anomaly is suspicious. However, it has been observed that sometimes the anomaly shows in the pattern of simultaneous deviation of principle component and quality parameter. The curve shape is deformed as well, to some degree. Thus, in certain embodiments, it may not be possible to use the quality measure on a target basis. However, if the quality parameter is very high, e.g., greater than 6 standard deviations, it should be considered significant.

Still, if more than half the targets exhibit high value of Qⁱ_{A}, this means that something has gone wrong with sample preparation. Thus, it is found that use of an additional quality parameter is advantageous, for example, the following:

Q50_{A}=medianᵢ(\tilde{Q}ⁱ_{A}) (24)

where \tilde{Q}ⁱ_{A} is the normalized quality parameter analogous to \tilde{R}ⁱ_{A}.

In the event of high noise, it may be that the orthogonal components exhibit very high noise and Q50 fails to indicate anomalous behavior. In this situation, it is advantageous to define another quality parameter that identifies bad sample preparation. For example, if a sample scores deviations in too many targets, then it is not likely to be a well prepared sample, and the following quality parameter will indicate this:

QZ_{A}=medianᵢ(\tilde{R}ⁱ_{A}) (25)

Thus, a combination of Q50 and QZ can be used to distinguish bad samples. It is also possible to use quantiles as quality parameters, for example, a high value of Q80, as defined below, indicates that at least 20% of the targets are suffering from anomalous curve shapes.

Q80_{A}=quantleᵢ(0.80,\tilde{Q}ⁱ_{A}) (26)

In some embodiments, a gender for each of the first through n^{th} patient samples may be determined by determining a principal component and corresponding parallel component for a Y chromosome target and identifying a deviation from a threshold value (e.g., as reflected in a readout based on a multiple of threshold value) indicative of a signal from a male or female sample using the corresponding parallel component (252). In determining gender for the patient samples, for example, male and female samples are separated, and modified principal component analysis is applied to both classes. Described below are two methods for gender determination—control-based testing and blind clustering.

In the example of control-based testing, based upon male control samples a principal component (median) for the Y chromosome is determined. Subsequently, amplitudes of parallel components for both male and female controls are identified. Threshold, for example, is chosen as geometric mean of medians of the male and female amplitudes. If signals are exhibiting a noise level that substantially is proportional to the square root of the signal, then the value between the two readouts that has equal probability of belonging to one or the other cluster is as follows:

Threshold=a+x*\sqrt{a}=b−x*\sqrt{b} (27)

Finding x from the two conditions, it is found that:

Threshold=\sqrt{a*b} (28)

The sample is then identified to be from a female patient if the Y chromosome signal is below the threshold, and male, otherwise.

In another example, if there are no control wells, it is possible to use a blind clustering algorithm to separate main groups of samples in Y. For example, for each Y primary signal, a threshold may be defined by applying the Otsu Nobuyuki method, which identifies threshold as a minimum of intraclass variance, as follows:

Threshold=minₜ(N_{F}(t)/N*σ_{F}(t)+N_{M}(t)/N*σ_{M}(t)) (29)

where N is the total number of data points, N_{F} is the number of points below threshold t, σ_{F}(t) is the standard deviation below threshold, and N_{M},σ_{M}(t) are the corresponding quantities above threshold.

Then, a first Y-curve may be obtained for low values that are identified with females, and a second Y-curve may be obtained for high values that are identified with males. The reference values of both curves serve as respective levels for both genders. To determine gender, a threshold may be placed in the middle of the reference values (e.g., the geometric mean derived via equation (28)), then the parallel amplitude for all samples may be calculated against the male Y-curve principal component. All patient samples above the threshold are identified as male, and all below the threshold are identified as female.

It should be noted that embodiments of the present disclosure may be provided as one or more computer-readable programs embodied on or in one or more articles of manufacture. The article of manufacture may be any suitable hardware apparatus, such as, for example, a floppy disk, a hard disk, a CD ROM, a CD-RW, a CD-R, a DVD ROM, a DVD-RW, a DVD-R, a flash memory card, a PROM, a RAM, a ROM, or a magnetic tape. In general, the computer-readable programs may be implemented in any programming language. Some examples of languages that may be used include C, C++, or JAVA. The software programs may be further translated into machine language or virtual machine instructions and stored in a program file in that form. The program file may then be stored on or in one or more of the articles of manufacture.

A computer hardware apparatus may be used in carrying out any of the methods described herein. The apparatus may include, for example, a general purpose computer, an embedded computer, a laptop or desktop computer, or any other type of computer that is capable of running software, issuing suitable control commands, receiving graphical user input, and recording information. The computer typically includes one or more central processing units for executing the instructions contained in software code that embraces one or more of the methods described herein. The software may include one or more modules recorded on machine-readable media, where the term machine-readable media encompasses software, hardwired logic, firmware, object code, and the like. Additionally, communication buses and I/O ports may be provided to link any or all of the hardware components together and permit communication with other computers and computer networks, including the internet, as desired. The computer may include a memory or register for storing data.

In certain embodiments, the modules described herein may be software code or portions of software code. For example, a module may be a single subroutine, more than one subroutine, and/or portions of one or more subroutines. The module may also reside on more than one machine or computer. In certain embodiments, a module defines data by creating the data, receiving the data, and/or providing the data. The module may reside on a local computer, or may be accessed via network, such as the Internet. Modules may overlap—for example, one module may contain code that is part of another module, or is a subset of another module.

The computer can be a general purpose computer, such as a commercially available personal computer that includes a CPU, one or more memories, one or more storage media, one or more output devices, such as a display, and one or more input devices, such as a keyboard. The computer operates using any commercially available operating system, such as any version of the Windows™ operating systems from Microsoft Corporation of Redmond, Wash., or the Linux™ operating system from Red Hat Software of Research Triangle Park, N.C. The computer is programmed with software including commands that, when operating, direct the computer in the performance of the methods of the illustrative embodiments. Those of skill in the programming arts will recognize that some or all of the commands can be provided in the form of software, in the form of programmable hardware such as flash memory, ROM, or programmable gate arrays (PGAs), in the form of hard-wired circuitry, or in some combination of two or more of software, programmed hardware, or hard-wired circuitry. Commands that control the operation of a computer are often grouped into units that perform a particular action, such as receiving information, processing information or data, and providing information to a user. Such a unit can comprise any number of instructions, from a single command, such as a single machine language instruction, to a set of commands, such as a set of lines of code written in a higher level programming language such as C++. Such units of commands are referred to generally as modules, whether the commands include software, programmed hardware, hard-wired circuitry, or a combination thereof. The computer and/or the software includes modules that accept input from input devices, that provide output signals to output devices, and that maintain the orderly operation of the computer. The computer also includes at least one module that renders images and text on the display. In alternative embodiments, the computer is a laptop computer, a minicomputer, a mainframe computer, an embedded computer, or a handheld computer. The memory is any conventional memory such as, but not limited to, semiconductor memory, optical memory, or magnetic memory. The storage medium is any conventional machine-readable storage medium such as, but not limited to, floppy disk, hard disk, CD-ROM, and/or magnetic tape. The display is any conventional display such as, but not limited to, a video monitor, a printer, a speaker, an alphanumeric display. The input device is any conventional input device such as, but not limited to, a keyboard, a mouse, a touch screen, a microphone, and/or a remote control. The computer can be a stand-alone computer or interconnected with at least one other computer by way of a network. This may be an internet connection.

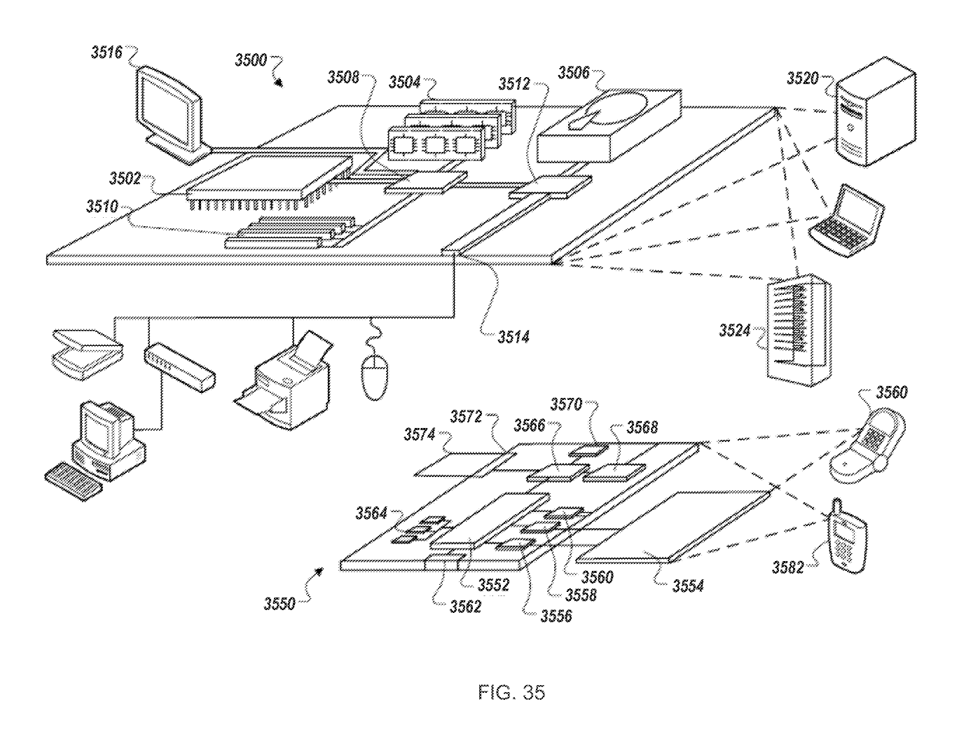

FIG. 35 shows an example of a computing device 3500 and a mobile computing device 3550 that can be used to implement the techniques described in this disclosure. The computing device 3500 is intended to represent various forms of digital computers, such as laptops, desktops, workstations, personal digital assistants, servers, blade servers, mainframes, and other appropriate computers. The mobile computing device 3550 is intended to represent various forms of mobile devices, such as personal digital assistants, cellular telephones, smart-phones, and other similar computing devices. The components shown here, their connections and relationships, and their functions, are meant to be examples only, and are not meant to be limiting.

The computing device 3500 includes a processor 3502, a memory 3504, a storage device 3506, a high-speed interface 3508 connecting to the memory 3504 and multiple high-speed expansion ports 3510, and a low-speed interface 3512 connecting to a low-speed expansion port 3514 and the storage device 3506. Each of the processor 3502, the memory 3504, the storage device 3506, the high-speed interface 3508, the high-speed expansion ports 3510, and the low-speed interface 3512, are interconnected using various busses, and may be mounted on a common motherboard or in other manners as appropriate. The processor 3502 can process instructions for execution within the computing device 3500, including instructions stored in the memory 3504 or on the storage device 3506 to display graphical information for a GUI on an external input/output device, such as a display 3516 coupled to the high-speed interface 3508. In other implementations, multiple processors and/or multiple buses may be used, as appropriate, along with multiple memories and types of memory. Also, multiple computing devices may be connected, with each device providing portions of the necessary operations (e.g., as a server bank, a group of blade servers, or a multi-processor system).

The memory 3504 stores information within the computing device 3500. In some implementations, the memory 3504 is a volatile memory unit or units. In some implementations, the memory 3504 is a non-volatile memory unit or units. The memory 3504 may also be another form of computer-readable medium, such as a magnetic or optical disk.

The storage device 3506 is capable of providing mass storage for the computing device 3500. In some implementations, the storage device 3506 may be or contain a computer-readable medium, such as a floppy disk device, a hard disk device, an optical disk device, or a tape device, a flash memory or other similar solid state memory device, or an array of devices, including devices in a storage area network or other configurations. Instructions can be stored in an information carrier. The instructions, when executed by one or more processing devices (for example, processor 3502), perform one or more methods, such as those described above. The instructions can also be stored by one or more storage devices such as computer- or machine-readable mediums (for example, the memory 3504, the storage device 3506, or memory on the processor 3502).

The high-speed interface 3508 manages bandwidth-intensive operations for the computing device 3500, while the low-speed interface 3512 manages lower bandwidth-intensive operations. Such allocation of functions is an example only. In some implementations, the high-speed interface 3508 is coupled to the memory 3504, the display 3516 (e.g., through a graphics processor or accelerator), and to the high-speed expansion ports 3510, which may accept various expansion cards (not shown). In the implementation, the low-speed interface 3512 is coupled to the storage device 3506 and the low-speed expansion port 3514. The low-speed expansion port 3514, which may include various communication ports (e.g., USB, Bluetooth®, Ethernet, wireless Ethernet) may be coupled to one or more input/output devices, such as a keyboard, a pointing device, a scanner, or a networking device such as a switch or router, e.g., through a network adapter.

The computing device 3500 may be implemented in a number of different forms, as shown in the figure. For example, it may be implemented as a standard server 3520, or multiple times in a group of such servers. In addition, it may be implemented in a personal computer such as a laptop computer 3522. It may also be implemented as part of a rack server system 3524. Alternatively, components from the computing device 3500 may be combined with other components in a mobile device (not shown), such as a mobile computing device 3550. Each of such devices may contain one or more of the computing device 3500 and the mobile computing device 3550, and an entire system may be made up of multiple computing devices communicating with each other.

The mobile computing device 3550 includes a processor 3552, a memory 3564, an input/output device such as a display 3554, a communication interface 3566, and a transceiver 3568, among other components. The mobile computing device 3550 may also be provided with a storage device, such as a micro-drive or other device, to provide additional storage. Each of the processor 3552, the memory 3564, the display 3554, the communication interface 3566, and the transceiver 3568, are interconnected using various buses, and several of the components may be mounted on a common motherboard or in other manners as appropriate.

The processor 3552 can execute instructions within the mobile computing device 3550, including instructions stored in the memory 3564. The processor 3552 may be implemented as a chipset of chips that include separate and multiple analog and digital processors. The processor 3552 may provide, for example, for coordination of the other components of the mobile computing device 3550, such as control of user interfaces, applications run by the mobile computing device 3550, and wireless communication by the mobile computing device 3550.

The processor 3552 may communicate with a user through a control interface 3558 and a display interface 3556 coupled to the display 3554. The display 3554 may be, for example, a TFT (Thin-Film-Transistor Liquid Crystal Display) display or an OLED (Organic Light Emitting Diode) display, or other appropriate display technology. The display interface 3556 may comprise appropriate circuitry for driving the display 3554 to present graphical and other information to a user. The control interface 3558 may receive commands from a user and convert them for submission to the processor 3552. In addition, an external interface 3562 may provide communication with the processor 3552, so as to enable near area communication of the mobile computing device 3550 with other devices. The external interface 3562 may provide, for example, for wired communication in some implementations, or for wireless communication in other implementations, and multiple interfaces may also be used.

The memory 3564 stores information within the mobile computing device 3550. The memory 3564 can be implemented as one or more of a computer-readable medium or media, a volatile memory unit or units, or a non-volatile memory unit or units. An expansion memory 3574 may also be provided and connected to the mobile computing device 3550 through an expansion interface 3572, which may include, for example, a SIMM (Single In Line Memory Module) card interface. The expansion memory 3574 may provide extra storage space for the mobile computing device 3550, or may also store applications or other information for the mobile computing device 3550. Specifically, the expansion memory 3574 may include instructions to carry out or supplement the processes described above, and may include secure information also. Thus, for example, the expansion memory 3574 may be provide as a security module for the mobile computing device 3550, and may be programmed with instructions that permit secure use of the mobile computing device 3550. In addition, secure applications may be provided via the SIMM cards, along with additional information, such as placing identifying information on the SIMM card in a non-hackable manner.

The memory may include, for example, flash memory and/or NVRAM memory (non-volatile random access memory), as discussed below. In some implementations, instructions are stored in an information carrier. that the instructions, when executed by one or more processing devices (for example, processor 3552), perform one or more methods, such as those described above. The instructions can also be stored by one or more storage devices, such as one or more computer- or machine-readable mediums (for example, the memory 3564, the expansion memory 3574, or memory on the processor 3552). In some implementations, the instructions can be received in a propagated signal, for example, over the transceiver 3568 or the external interface 3562.

The mobile computing device 3550 may communicate wirelessly through the communication interface 3566, which may include digital signal processing circuitry where necessary. The communication interface 3566 may provide for communications under various modes or protocols, such as GSM voice calls (Global System for Mobile communications), SMS (Short Message Service), EMS (Enhanced Messaging Service), or MMS messaging (Multimedia Messaging Service), CDMA (code division multiple access), TDMA (time division multiple access), PDC (Personal Digital Cellular), WCDMA (Wideband Code Division Multiple Access), CDMA2000, or GPRS (General Packet Radio Service), among others. Such communication may occur, for example, through the transceiver 3568 using a radio-frequency. In addition, short-range communication may occur, such as using a Bluetooth®, Wi-Fi™, or other such transceiver (not shown). In addition, a GPS (Global Positioning System) receiver module 3570 may provide additional navigation- and location-related wireless data to the mobile computing device 3550, which may be used as appropriate by applications running on the mobile computing device 3550.

The mobile computing device 3550 may also communicate audibly using an audio codec 3560, which may receive spoken information from a user and convert it to usable digital information. The audio codec 3560 may likewise generate audible sound for a user, such as through a speaker, e.g., in a handset of the mobile computing device 3550. Such sound may include sound from voice telephone calls, may include recorded sound (e.g., voice messages, music files, etc.) and may also include sound generated by applications operating on the mobile computing device 3550.

The mobile computing device 3550 may be implemented in a number of different forms, as shown in the figure. For example, it may be implemented as a cellular telephone 3580. It may also be implemented as part of a smart-phone 3582, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms machine-readable medium and computer-readable medium refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term machine-readable signal refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

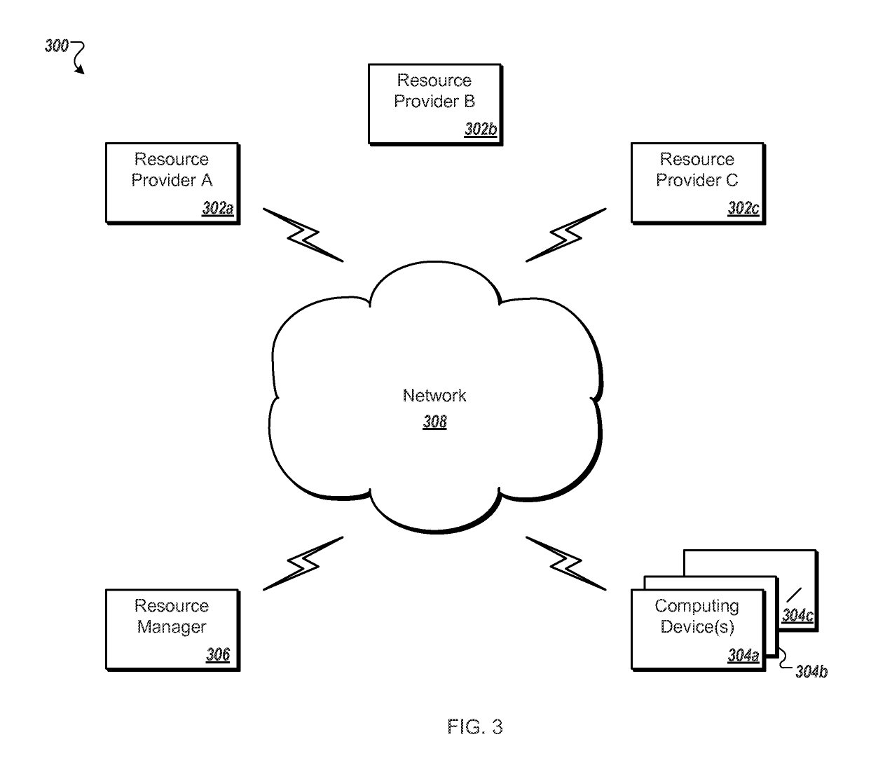

As shown in FIG. 3, an implementation of a network environment 300 for detection of chromosomal gains and losses is shown and described. In brief overview, Referring now to FIG. 3, a block diagram of an exemplary cloud computing environment 300 is shown and described. The cloud computing environment 300 may include one or more resource providers 302a, 302b, 302c (collectively, 302). Each resource provider 302 may include computing resources. In some implementations, computing resources may include any hardware and/or software used to process data. For example, computing resources may include hardware and/or software capable of executing algorithms, computer programs, and/or computer applications. In some implementations, exemplary computing resources may include application servers and/or databases with storage and retrieval capabilities. Each resource provider 302 may be connected to any other resource provider 302 in the cloud computing environment 300. In some implementations, the resource providers 302 may be connected over a computer network 308. Each resource provider 302 may be connected to one or more computing device 304a, 304b, 304c (collectively, 304), over the computer network 308.

The cloud computing environment 300 may include a resource manager 306. The resource manager 306 may be connected to the resource providers 302 and the computing devices 304 over the computer network 308. In some implementations, the resource manager 306 may facilitate the provision of computing resources by one or more resource providers 302 to one or more computing devices 304. The resource manager 306 may receive a request for a computing resource from a particular computing device 304. The resource manager 306 may identify one or more resource providers 302 capable of providing the computing resource requested by the computing device 304. The resource manager 306 may select a resource provider 302 to provide the computing resource. The resource manager 306 may facilitate a connection between the resource provider 302 and a particular computing device 304. In some implementations, the resource manager 306 may establish a connection between a particular resource provider 302 and a particular computing device 304. In some implementations, the resource manager 306 may redirect a particular computing device 304 to a particular resource provider 302 with the requested computing resource.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (LAN), a wide area network (WAN), and the Internet.

The computing system can include clients and servers. A client and server are generally remote from each other and typically interact through a communication network. The relationship of client and server arises by virtue of computer programs running on the respective computers and having a client-server relationship to each other.

### EXAMPLES

### Example 1

### Detection of Chromosomal Targets Using Improved Statistical Methods

The Constitutional BoBs™ (BACs-on-Beads™) assay was used to detect the five most common aneuploidies (chromosomes 13, 18, 21, X and Y) and gains and losses in nine well-characterized target regions from genomic samples. Details of the assay are found in U.S. Pat. No. 7,932,037. Briefly, 83 PCR-amplified Bacterial Artificial Chromosome (BAC) clones (“probes”) covering regions of chromosomes 13, 18, 21, X and Y and nine additional microdeletion regions were attached to color-coded beads to enable molecular karyotyping in a well. Negative control beads were also used in the ratio algorithm, as described below. The assay included five probes for aneuploidy detection of chromosomes 13, 18, 21, X and Y and four to eight independent probes for the additional target regions. Genomic DNA was extracted from male and female reference samples and from each one of 14 cell lines shown in Table 1, which were obtained from the cell repository at the Coriell Institute for Medical Research (website: ccr.coriel.org). Each cell line contained one or more genetic abnormalities corresponding to the syndromes indicated in Table 1.

TABLE 1
Cell lines from which genomic DNA was extracted.

| Sample | | Coriell | |
|---|---|---|---|
| # | Syndrome | Catalog # | Coriell Characterization |
| 1 | WBS, Williams-Beuren 7q11 | NA13460 | 46, XX.ish del(7)(pter>q11.23:: |
| | | | q11.23>qter)(ELN−). |
| 2 | SMS, Smith-Magenis 17p11 | NA18319 | 46, XX, del(17) (pter>p11.2:: p11.2 >qter). |
| | | | ish del(17) (LIS1+, FLI−) |
| 3 | AS, Angleman 15q11 | NA11404 | 46, XY, del(15)(pter>q11:: q13 >qter). ish |
| | | | del(15) (D15Z1+, SNRPN−, PML+); |
| 4 | +21, Trisomy 21 | NA04592A | 47, XX, +21 |
| 5 | +18, XXX, Trisomy 18 and Trisomy X | NA03623 | 48, XXX, +18 |
| 6 | +13, Trisomy 13 | NA03330 | 47, XY, +13. |
| 7 | DGS 22q, DiGeorge 22q | NA07215A | 46, XX, DiGeorge syndrome confirmed by |
| | | | FISH to DGS region in chromosome 22 and |
| | | | phenotypic characterization |
| 8 | MDS, Miller-Dieker 17p13 | NA09208 | 46, XY, del(17)(qter> p13.1:) |
| 9 | WHS, Wolf-Hirschhorn 4p16 | NA00343 | 46, XY, del(4)(qter>p14:) |
| 10 | LGS, Langer-Giedion 8q23 | NA09888 | 46, XX, del(8)(pter>q23::q24.13>qter) |
| 11 | CDC, Cri-du-chat 5p15 | NA14129 | 45, X, dic(Y;5) (Ypter>Yq12 ::5p15.1>5qter). |
| | | | ish dic(Y;5)(DYZ1+,DYZ3+,D5S23−) |
| 12 | PWS, Prader-Willi 15q11 | NA11382 | 46, XY, del(15)(pter>q11::q13>qter) |
| 13 | XYY, Disomy Y | NA01993 | 47, XYY. |
| 14 | DGS 10p, DiGeorge 10p14 | NA03047 | 46, XY, del(10)(qter>p11:) |

Genomic DNA was labeled enzymatically with biotin and hybridized to the BAC-derived probes attached to beads in a 96-well plate. A fluorescent streptavidin-phycoerythrin reporter was bound to the biotin labels and excess reporter was washed away. The fluorescent signals generated by the kit were read by the Luminex® system (Luminex Corporation, Austin, Tex.) and analyzed with either the BoBsoft™ analysis software (PerkinElmer, Inc., Waltham, Mass.) “ratio algorithm” or the algorithm of the present disclosure.

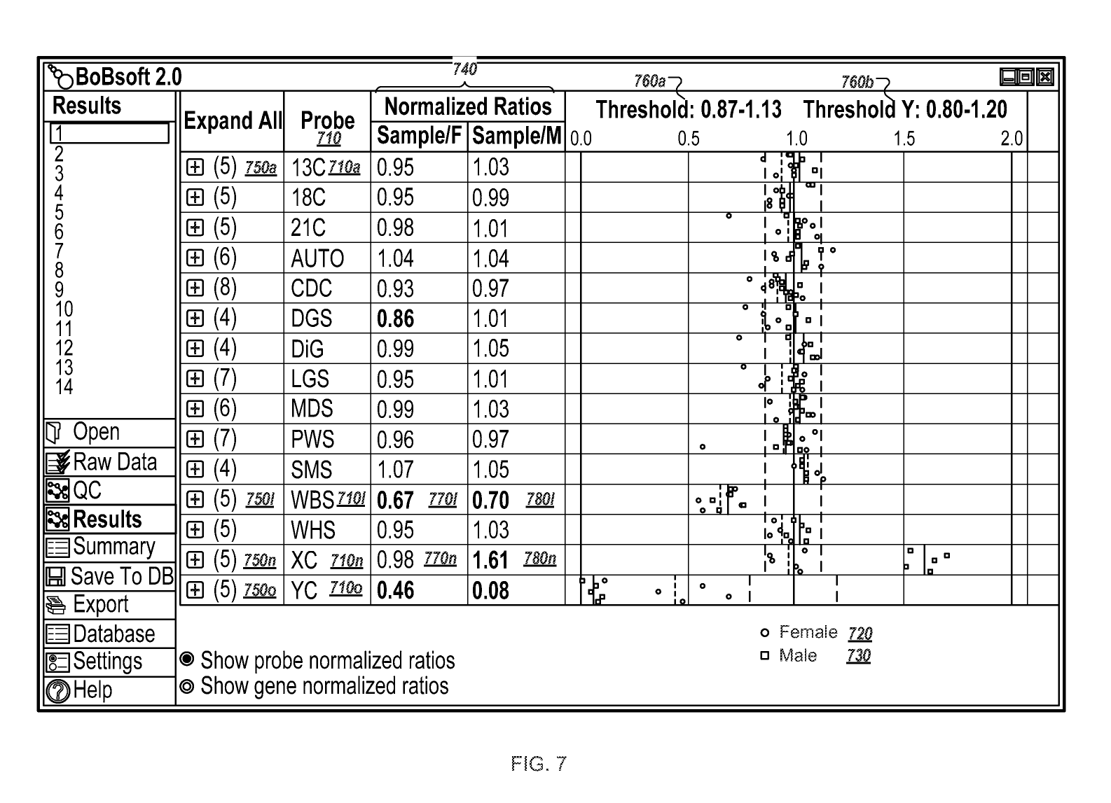

Results of the analysis are seen in FIGS. 7-34. FIG. 7 shows the assay results calculated by the ratio algorithm for Sample 1 (which contains a microdeletion in chromosome 7 associated with Williams-Beuren Syndrome (WBS)). These results were calculated using the median fluorescence values for each bead region produced by the Luminex reader. The average values of the negative control beads were then subtracted from all other signals. The signals from autosomal clones were then ratioed with the corresponding clone signals from the male and female reference DNAs. A normalization factor was calculated such that when the factor is applied to all of the autosomal clone signals it drove the average autosomal ratio to a value of one. This normalization factor was then applied to all of the signals for the sample. The resulting ratios are plotted and shown in FIG. 7.

In FIG. 7, a column 710 labeled “probe” indicates which syndrome (and therefore chromosomal region) was assayed. The probe nomenclature indicates the particular chromosome detected or the particular disorder with which a detected aneuploidy or microdeletion is associated, as depicted in Table 2.

TABLE 2
Listing of probes and their associated disorder or chromosome

| PROBE | Detects |
|---|---|
| 13C | Trisomy 13 (Patau Syndrome) |
| 18C | Edwards Syndrome (Trisomy 18) and Trisomy X |
| 21C | Trisomy 21 (Down Syndrome) |
| AUTO | Autosomal Control Probe |
| CDC | Cri-du-chat |
| DGS | DiGeorge 22q |
| DiG | DiGeorge 10p14 |
| LGS | Langer-Giedion |
| MDS | Miller-Dieker |
| PWS | Prader-Willi (same locus as Angleman Syndrome) |
| SMS | Smith-Magenis |
| WBS | Williams-Beuren |
| WHS | Wolf-Hirschhorn |
| XC | X Chromosome Probe |
| YC | Y Chromosome Probe |

Within a row for a particular probe 710, each data point corresponds to the data obtained from a single probe 710. Circular data points 720 represent the fluorescence values normalized to a female reference sample, and square data points 730 represent the fluorescence values normalized to a male reference sample. The numerical value of the average of each of the circular data points 720 or square data points 730 depicted under the columns labeled “Normalized Ratios” 740 as either “Sample/F” 740a or “Sample/M” 740b. For example, the first row shows the data collected from five probes covering chromosome 13C 710a; 5 circular data points 720 normalized to a female reference sample, and five square data points 730 normalized to a male reference sample.

Threshold values for each sample are established via the ratio method. As shown in FIG. 7, threshold values 760 were calculated to be between 0.87 to 1.13 (0.8-1.20 for the Y chromosome). Row 12 750l, which depicts the data obtained using probes to a microdeletion in chromosome 7 associated with Williams-Beuren Syndrome (WBS) 710l, shows normalized values 770l, 780l of 0.67 (Sample/F 770l) and 0.70 (Sample/M 780l) outside of the threshold range, indicating that this sample contains a microdeletion in chromosome 7. Rows 14 750n and 15 750o depict the data obtained using a probe to the X chromosome 710n and Y chromosome 710o. For the X-chromosome probe 710n (e.g., displayed in Row 14 750n), a ratio of almost 1.0 770n is seen when normalized to a female reference sample, and a ratio of about 1.6 780n is seen when normalized to a male reference sample, indicating that the sample is from a female.

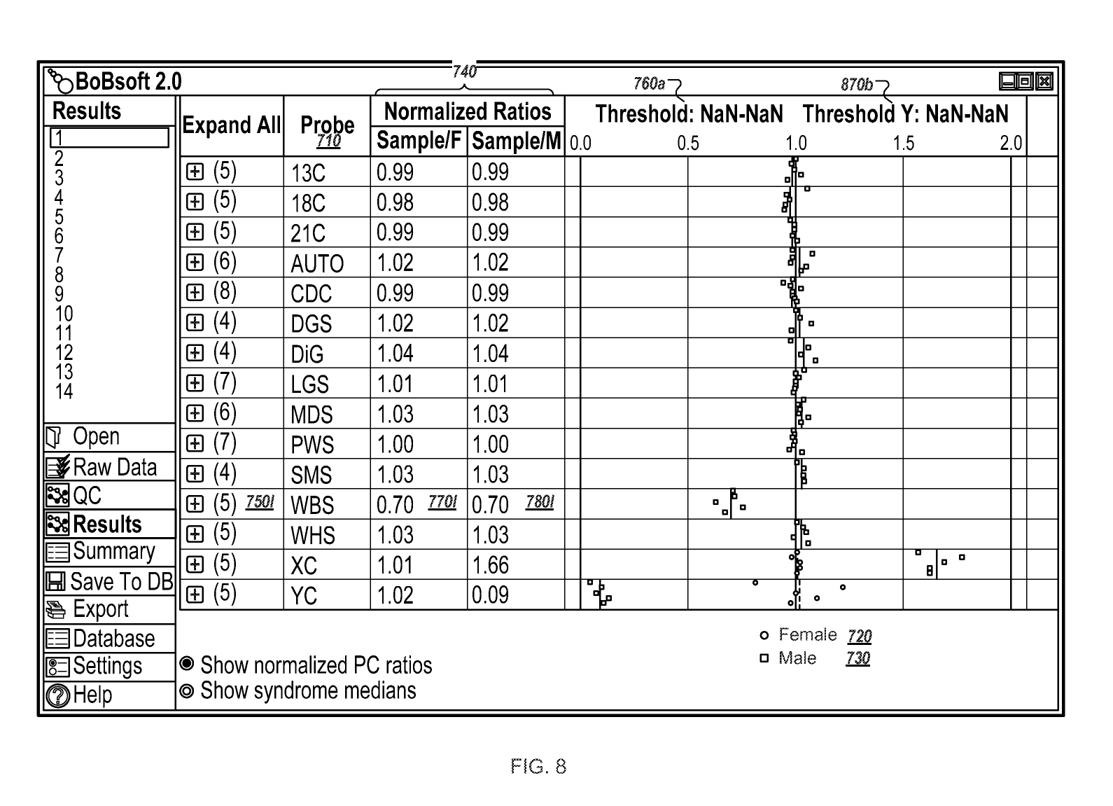

In comparison, FIG. 8 shows the assay results analyzed, for example, according to the exemplary method 200 described above in relation to FIG. 2. The fluorescence data analyzed according to at least a portion of the features described within the method 200 was the same data analyzed by the ratio method as depicted in FIG. 7. Threshold values for each sample are established by calculating 2× the coefficient of variation of trimmed autosomals. A region is counted as positive if three or more probes 710 have excursions beyond the threshold.

As depicted in FIG. 8, the analysis provided within the method 200 eliminates more noise than does the ratio analysis, allowing for a more accurate determination of the presence of a chromosomal abnormality in a sample.

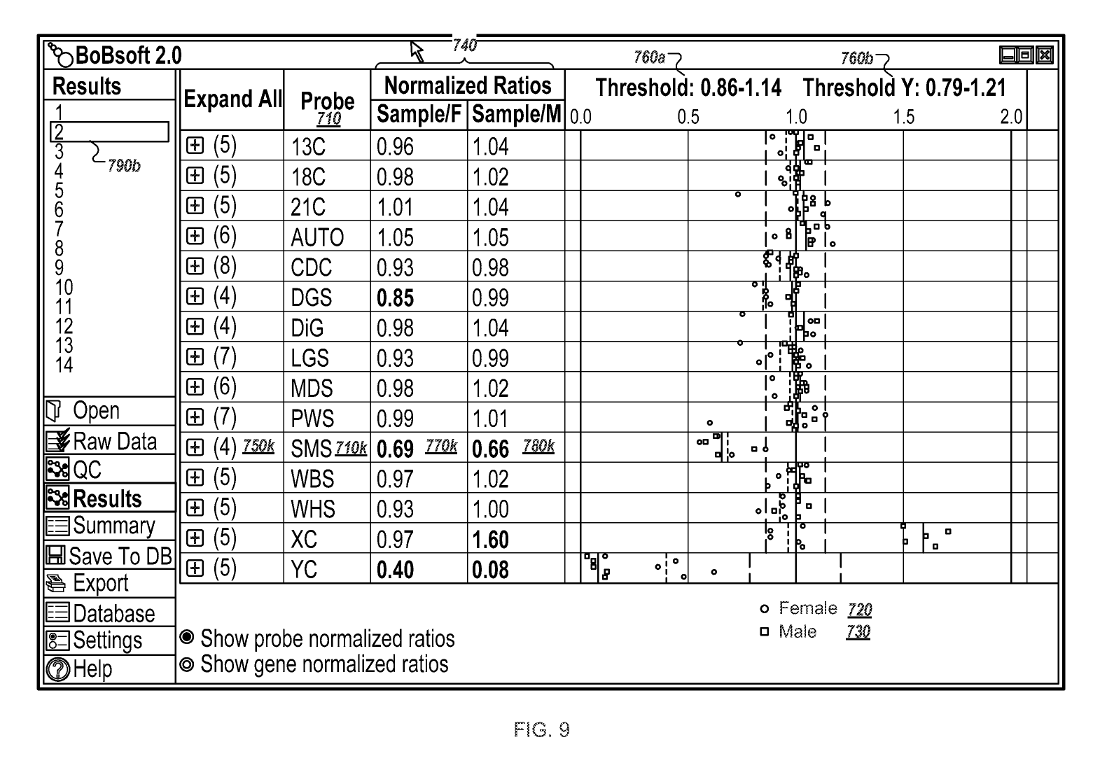

FIG. 9 shows assay results calculated by the ratio algorithm for Sample 2 (SMS, Smith-Magenis Syndrome) 790b, as described for FIG. 7. Row 11 750k, which depicts the data obtained using probes to a microdeletion in chromosome 17 associated with Smith-Magenis Syndrome (SMS) 710k, shows normalized values of 0.69 (Sample/F 770k) and 0.66 (Sample/M 780k) outside of the threshold range, indicating that this sample contains the microdeletion.

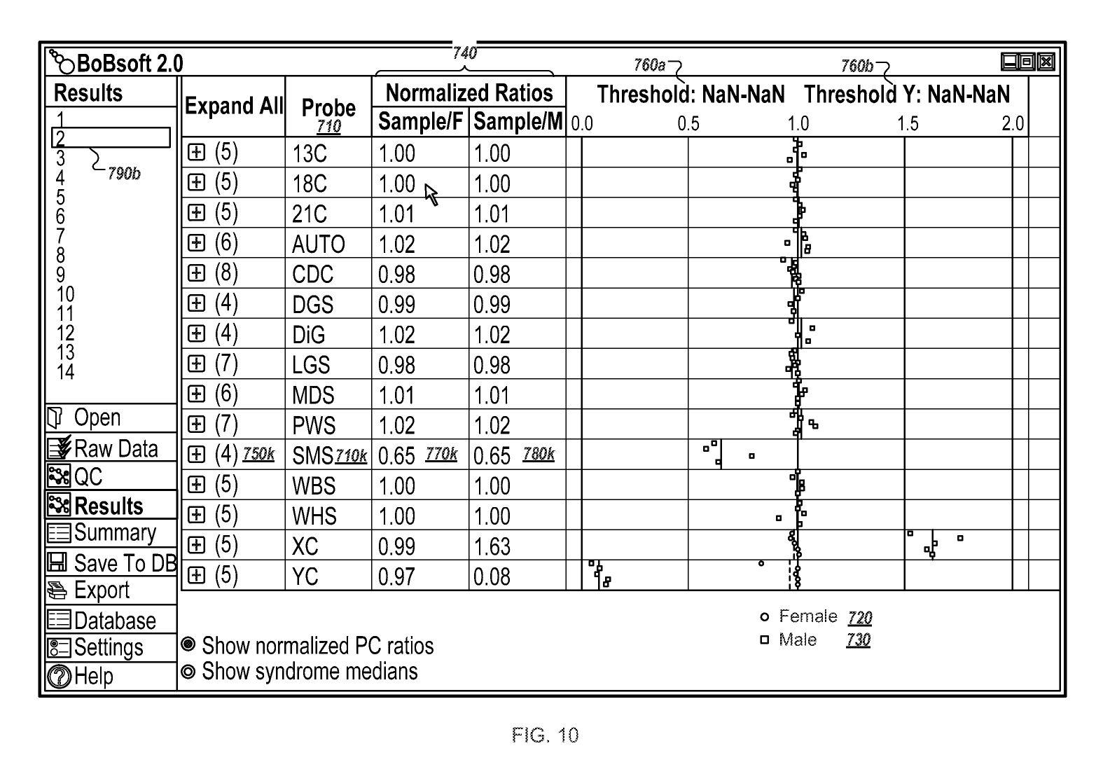

FIG. 10 shows the assay results analyzed, for example, according to the exemplary method 200 described above in relation to FIG. 2. The fluorescence data analyzed according to at least a portion of the features described within the method 200 was the same data analyzed by the ratio method as depicted in FIG. 9, but shows reduced noise, allowing for a more accurate determination of the presence of a chromosomal abnormality in the sample

FIG. 11 shows assay results calculated by the ratio algorithm for Sample 3 (AS, Angleman Syndrome) 790c, as described for FIG. 7. Row 10 750j, which depicts the data obtained using probes to a microdeletion in chromosome 15 associated with Prader Willi Syndrome (PWS) 710j and Angleman Syndrome (AS), shows normalized values of 0.62 (Sample/F 770j) and 0.63 (Sample/M 780j) outside of the threshold range, indicating that this sample contains the microdeletion.

FIG. 12 shows the assay results analyzed, for example, according to the exemplary method 200 described above in relation to FIG. 2. The fluorescence data analyzed according to at least a portion of the features described within the method 200 was the same data analyzed by the ratio method as depicted in FIG. 11, but shows reduced noise, allowing for a more accurate determination of the presence of a chromosomal abnormality in the sample.

FIG. 13 shows assay results calculated by the ratio algorithm for Sample 4 (Trisomy 21) 790d, as described for FIG. 7. Row 3 750c, which depicts the data obtained using probes to chromosome 21 710c, shows normalized values of 1.35 (Sample/F 770c) and 1.39 (Sample/M 780c) outside of the threshold range, indicating that this sample contains three copies of chromosome 21 (Trisomy 21).

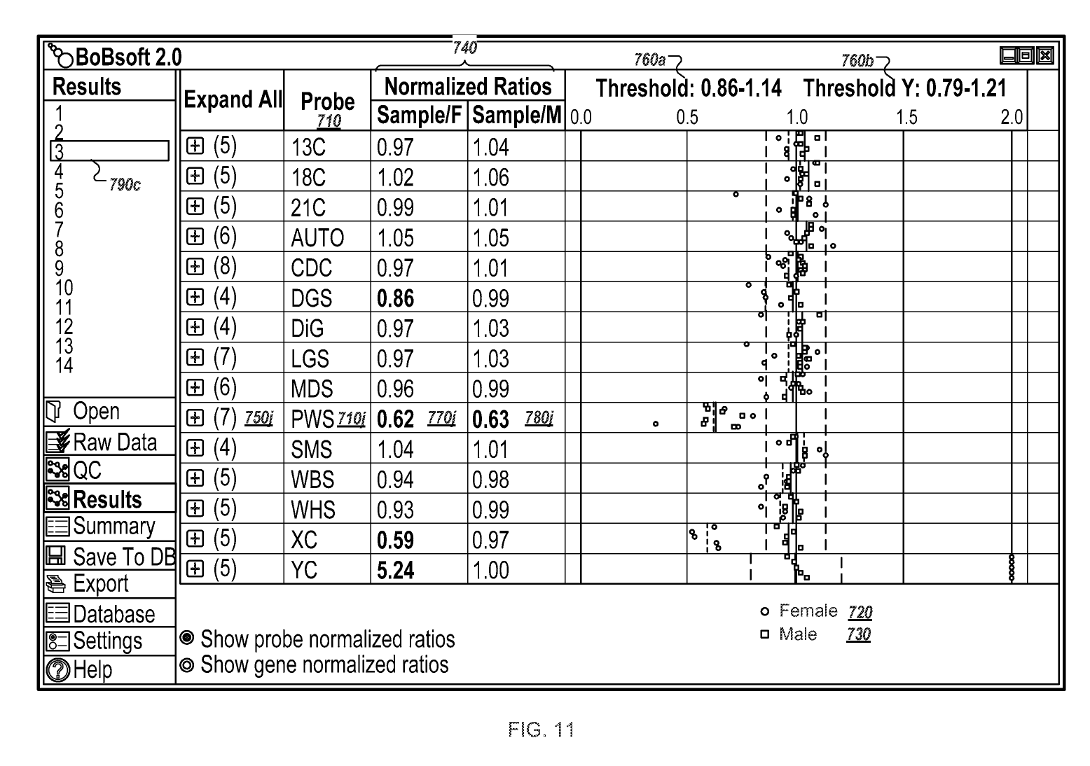

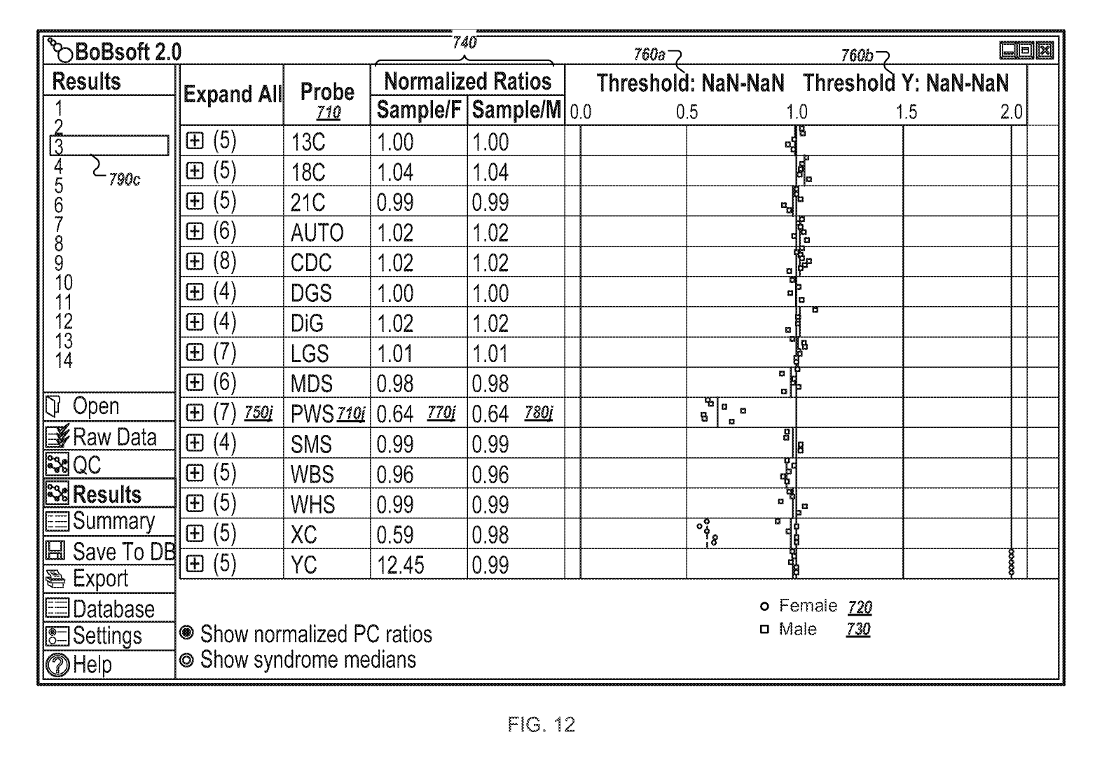

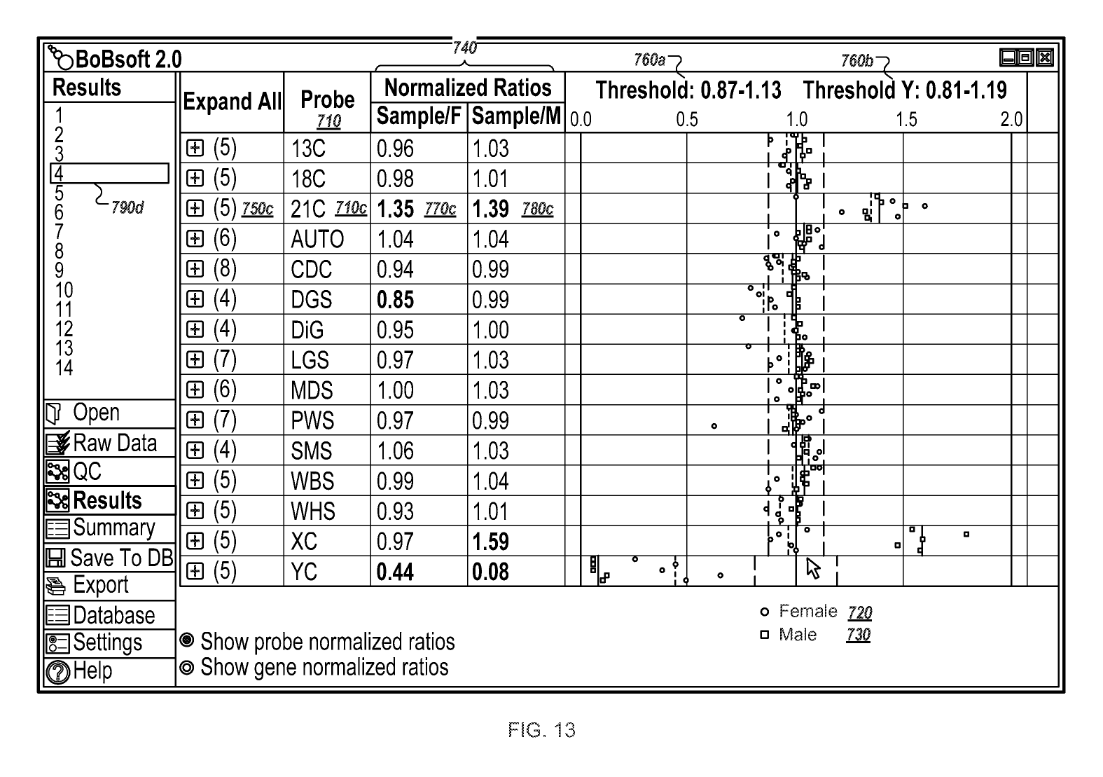

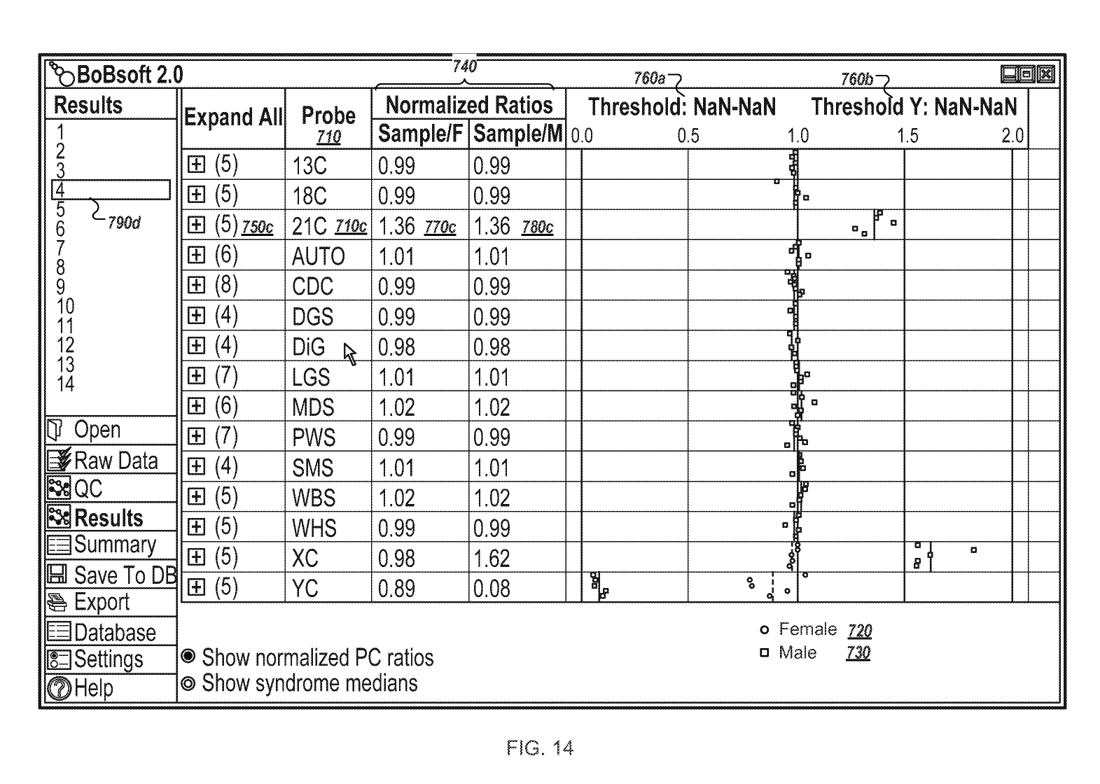

FIG. 14 shows the assay results analyzed, for example, according to the exemplary method 200 described above in relation to FIG. 2. The fluorescence data analyzed according to at least a portion of the features described within the method 200 was the same data analyzed by the ratio method as depicted in FIG. 13, but shows reduced noise, allowing for a more accurate determination of the presence of a chromosomal abnormality in the sample.

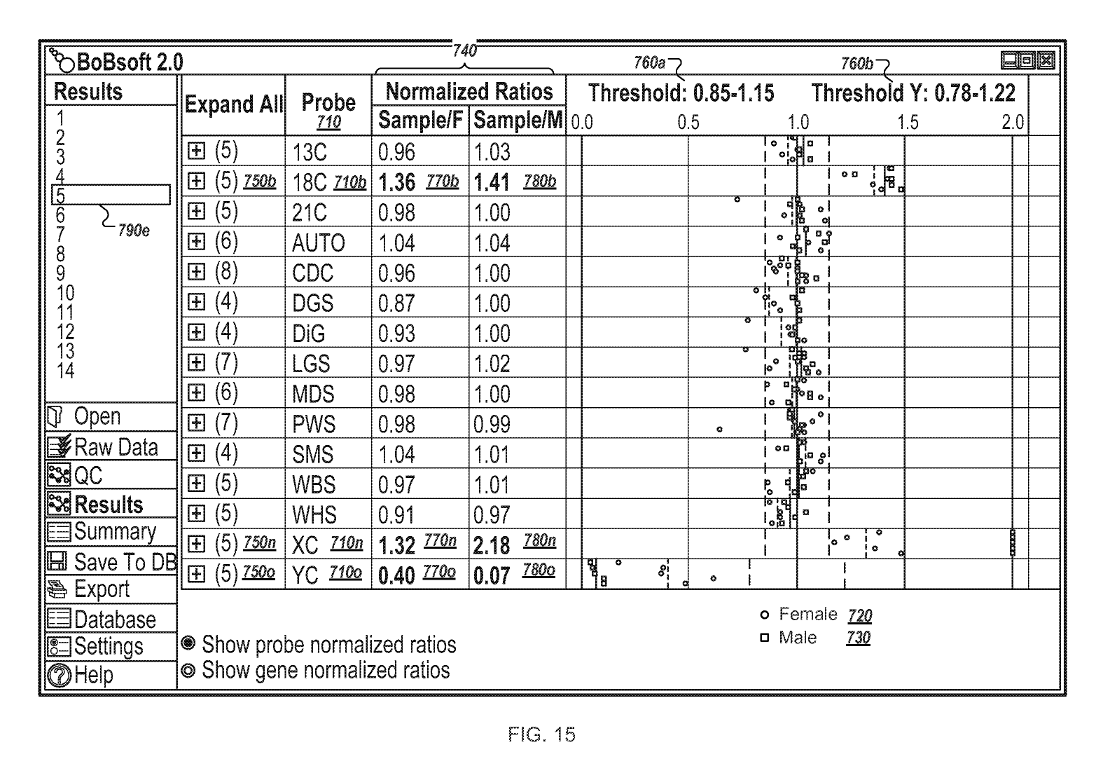

FIG. 15 shows assay results calculated by the ratio algorithm for Sample 5 (Trisomy 18 and Trisomy X) 790e, as described for FIG. 7. Row 2 750b, which depicts the data obtained using probes to chromosome 18 710b, shows normalized values of 1.36 (Sample/F 770b) and 1.41 (Sample/M 780b) outside of the threshold range, indicating that this sample contains three copies of chromosome 18 (Trisomy 18). Row 14, which depicts the data obtained using probes to the X chromosome 710n, shows normalized values of 1.32 (Sample/F 770n) and 2.18 (Sample/M 780n), indicating that this sample contains three copies of chromosome X. Similarly, Row 15 750o, which depicts the data obtained using probes to the Y chromosome 710o, shows normalized values of 0.40 (Sample/F 770o) and 0.07 (Sample/M 780o), indicating that this sample contains three copies of chromosome X.

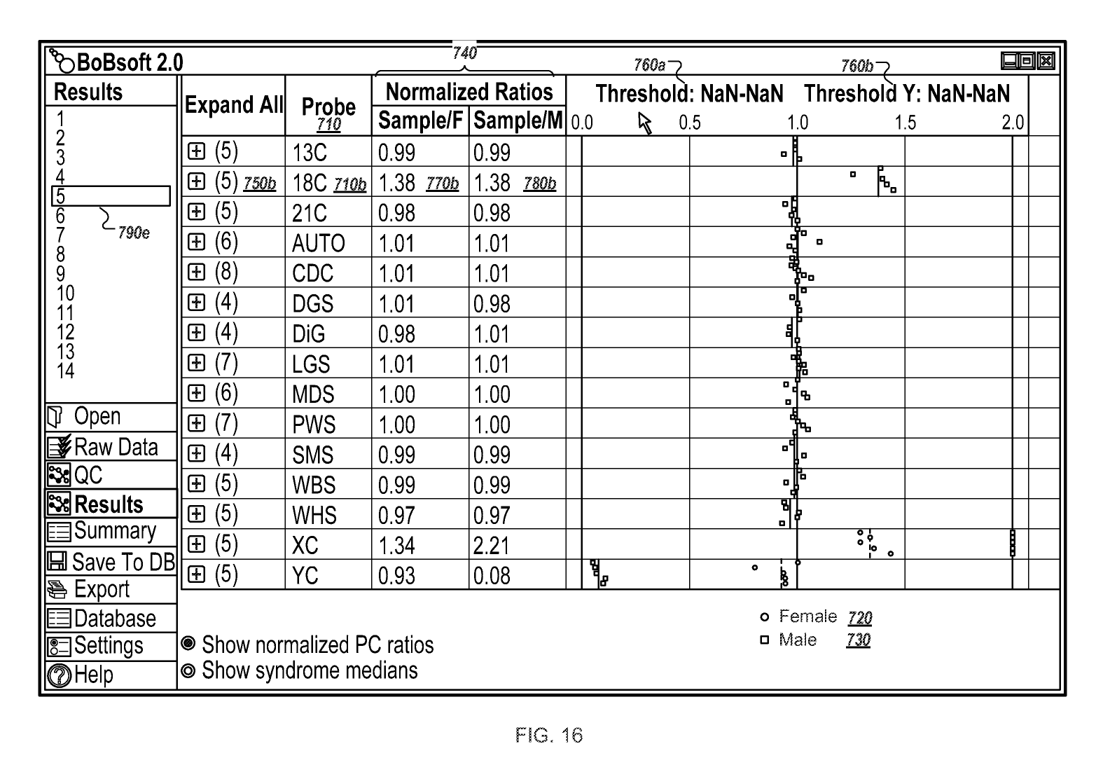

FIG. 16 shows the assay results analyzed, for example, according to the exemplary method 200 described above in relation to FIG. 2. The fluorescence data analyzed according to at least a portion of the features described within the method 200 was the same data analyzed by the ratio method as depicted in FIG. 15, but shows reduced noise, allowing for a more accurate determination of the presence of a chromosomal abnormality in the sample.

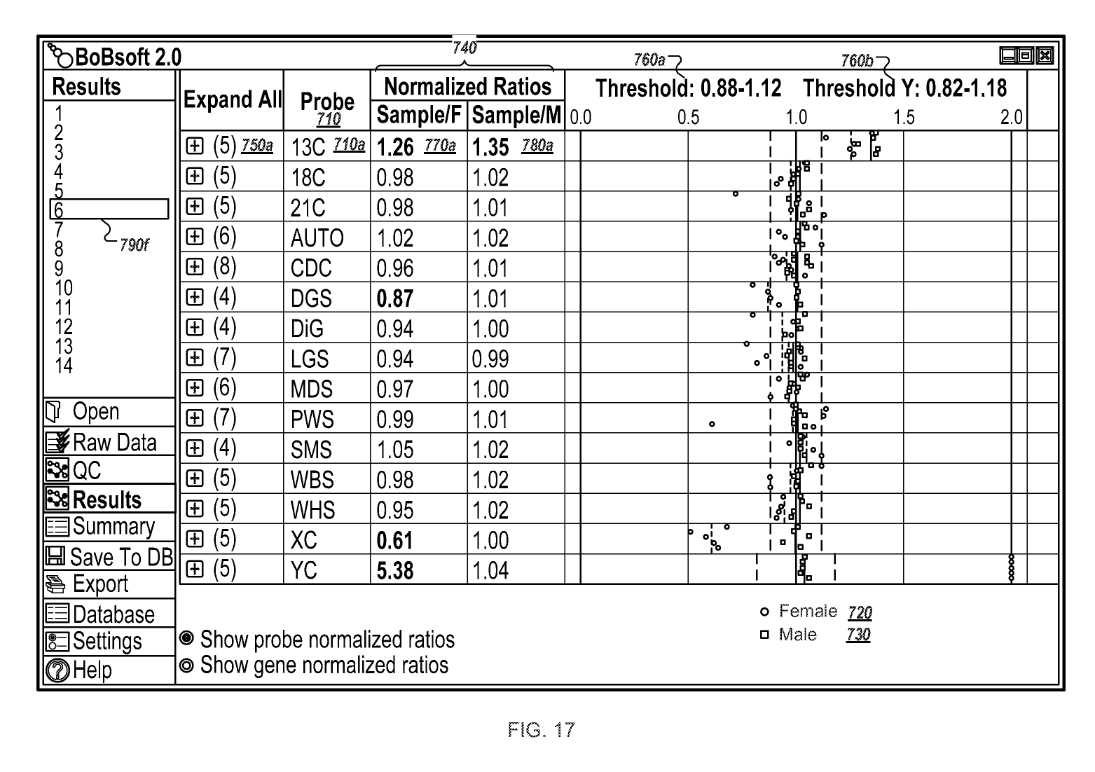

FIG. 17 shows assay results calculated by the ratio algorithm for Sample 6 (Trisomy 13) 790f as described for FIG. 7. Row 1 750a, which depicts the data obtained using probes to chromosome 13, shows normalized values of 1.26 (Sample/F 770a) and 1.35 (Sample/M 780a) outside of the threshold range, indicating that this sample contains three copies of chromosome 13 (Trisomy 13).

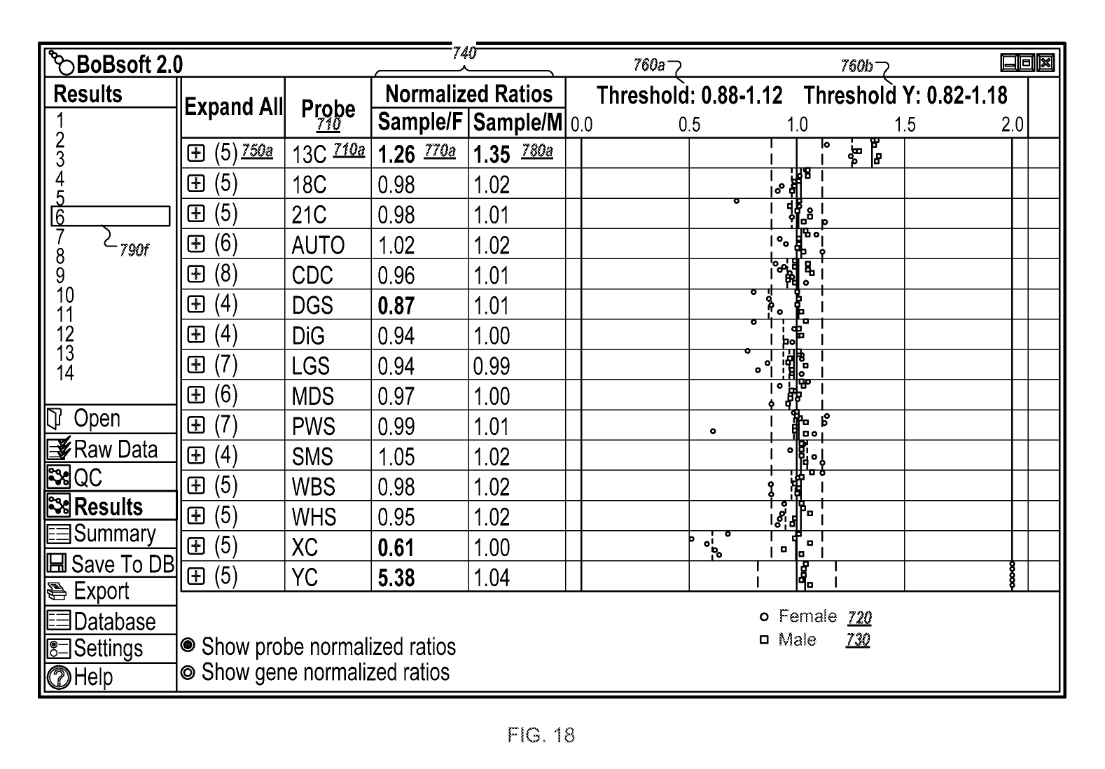

FIG. 18 shows the assay results analyzed, for example, according to the exemplary method 200 described above in relation to FIG. 2. The fluorescence data analyzed according to at least a portion of the features described within the method 200 was the same data analyzed by the ratio method as depicted in FIG. 17, but shows reduced noise, allowing for a more accurate determination of the presence of a chromosomal abnormality in the sample.

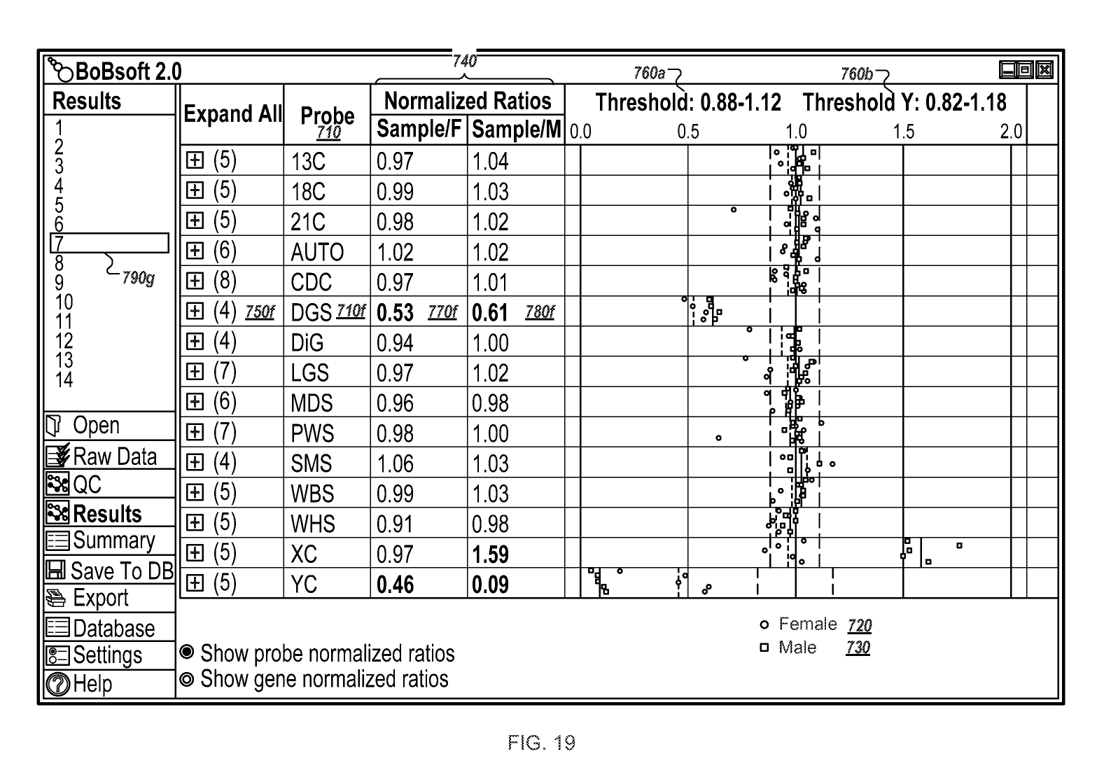

FIG. 19 shows assay results calculated by the ratio algorithm for Sample 7 (DiGeorge 22q) 790g as described for FIG. 7. Row 6 750f, which depicts the data obtained using probes to the microdeletion in chromosome 22 associated with Di George Syndrome 710f, shows normalized values of 0.53 (Sample/F 770f) and 0.61 (Sample/M 780f) outside of the threshold range, indicating that this sample contains the microdeletion.

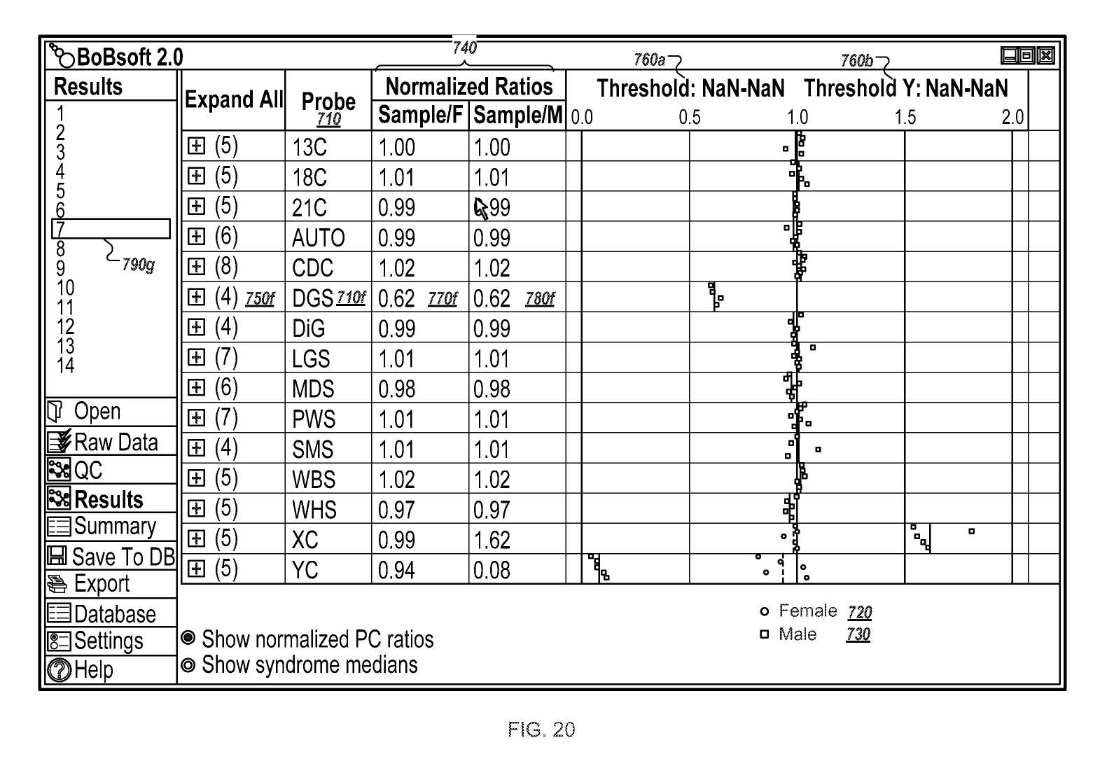

FIG. 20 shows the assay results analyzed, for example, according to the exemplary method 200 described above in relation to FIG. 2. The fluorescence data analyzed according to at least a portion of the features described within the method 200 was the same data analyzed by the ratio method as depicted in FIG. 19, but shows reduced noise, allowing for a more accurate determination of the presence of a chromosomal abnormality in the sample.

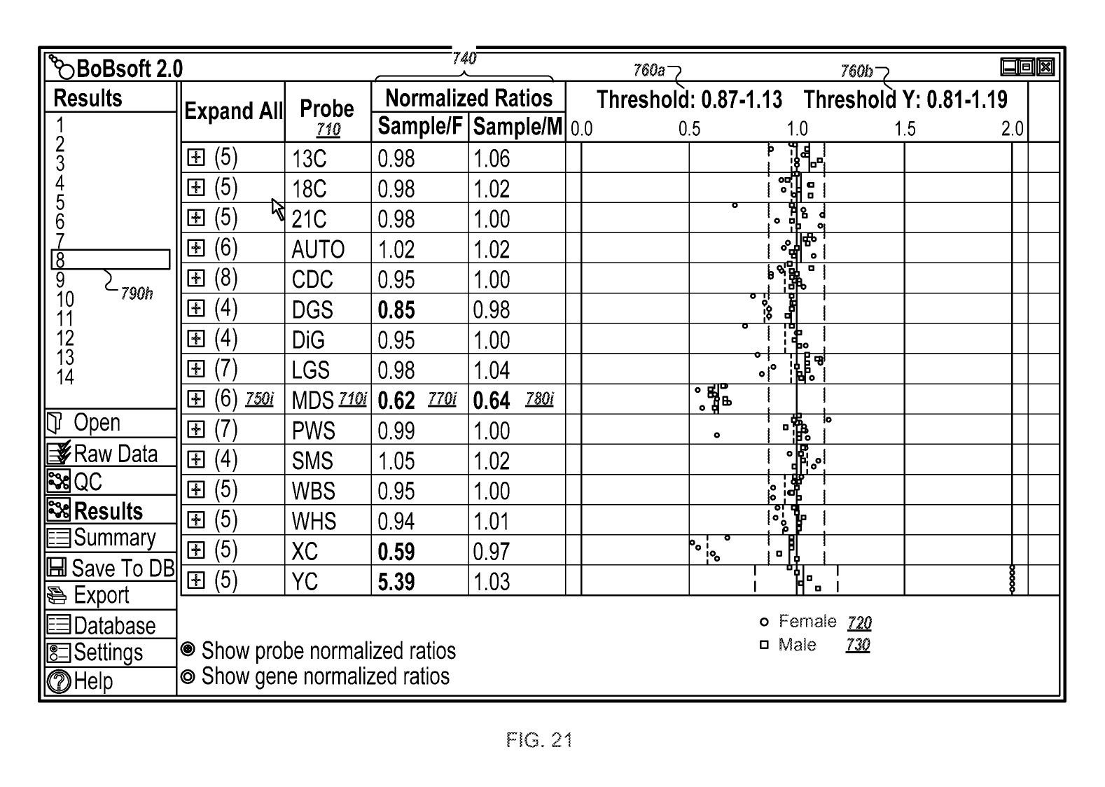

FIG. 21 shows assay results calculated by the ratio algorithm for Sample 8 (Miller Dieker Syndrome) 790h as described for FIG. 7. Row 9 750i, which depicts the data obtained using probes to the microdeletion in chromosome 17 associated with Miller Dieker Syndrome 710i, shows normalized values of 0.53 (Sample/F 770i) and 0.61 (Sample/M 780i) outside of the threshold range, indicating that this sample contains the microdeletion.

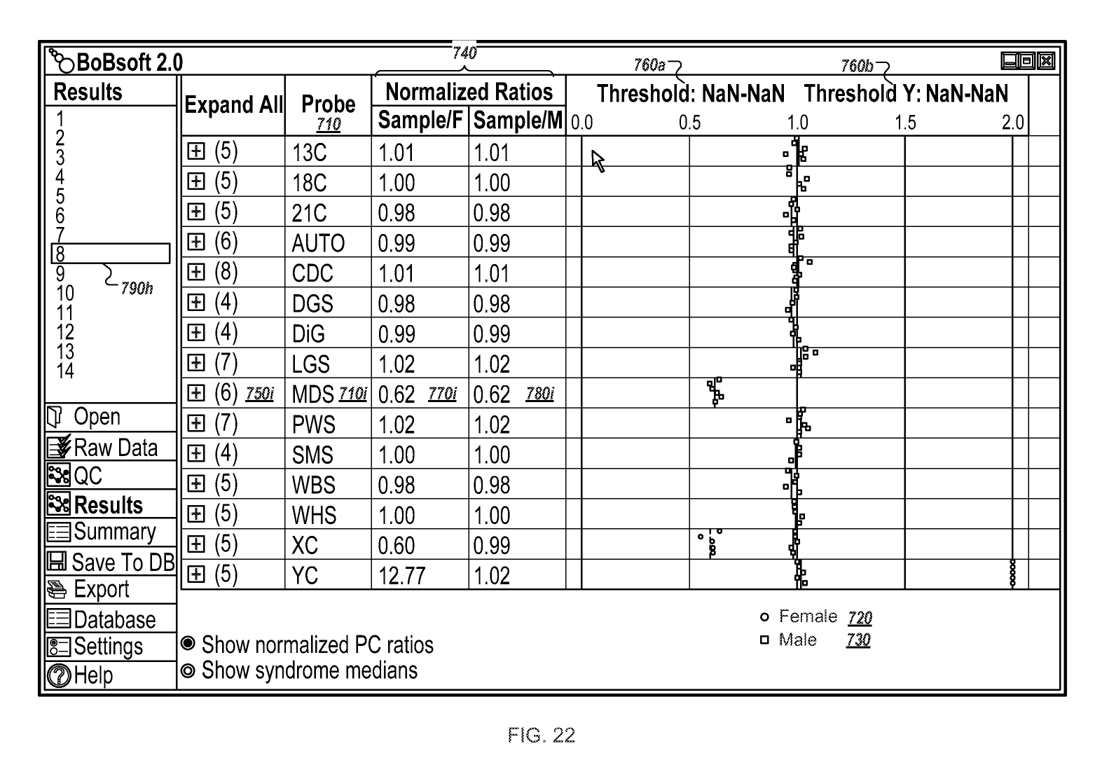

FIG. 22 shows the assay results analyzed, for example, according to the exemplary method 200 described above in relation to FIG. 2. The fluorescence data analyzed according to at least a portion of the features described within the method 200 was the same data analyzed by the ratio method as depicted in FIG. 21, but shows reduced noise, allowing for a more accurate determination of the presence of a chromosomal abnormality in the sample.

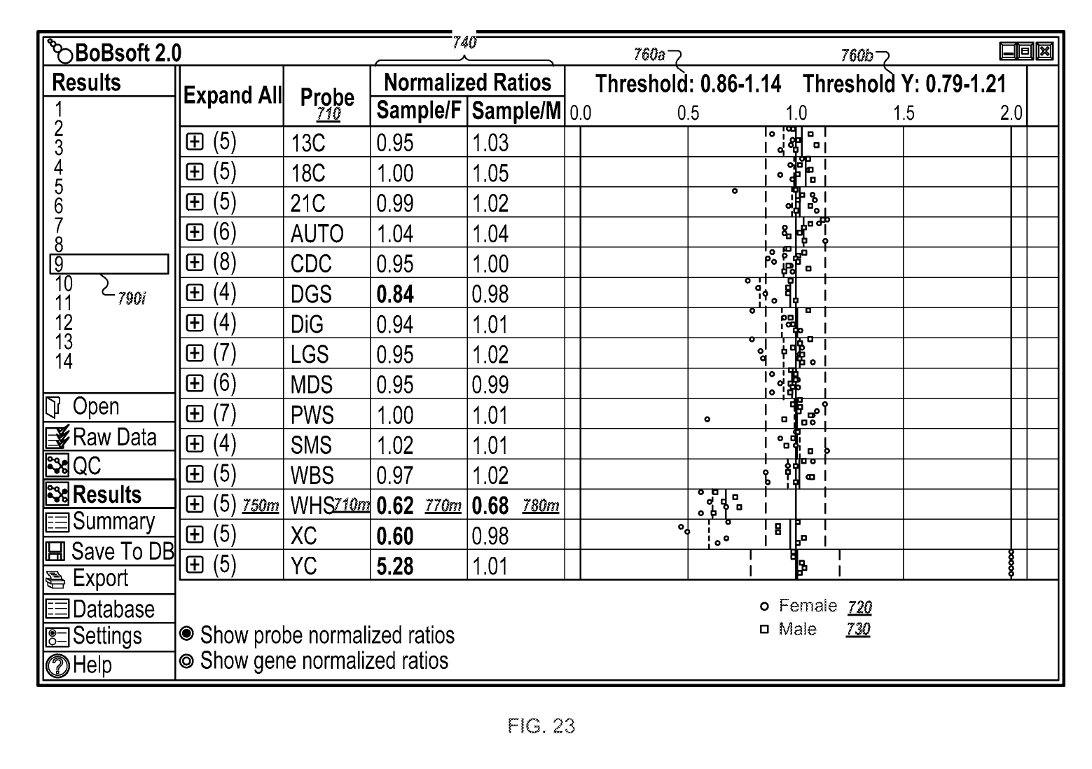

FIG. 23 shows assay results calculated by the ratio algorithm for Sample 9 (Wolf-Hirschhorn Syndrome) 790i as described for FIG. 7. Row 13 750m, which depicts the data obtained using probes to the microdeletion in chromosome 4 associated with Wolf-Hirschhorn Syndrome 710m, shows normalized values of 0.62 (Sample/F 770m) and 0.68 (Sample/M 780m) outside of the threshold range, indicating that this sample contains the microdeletion.

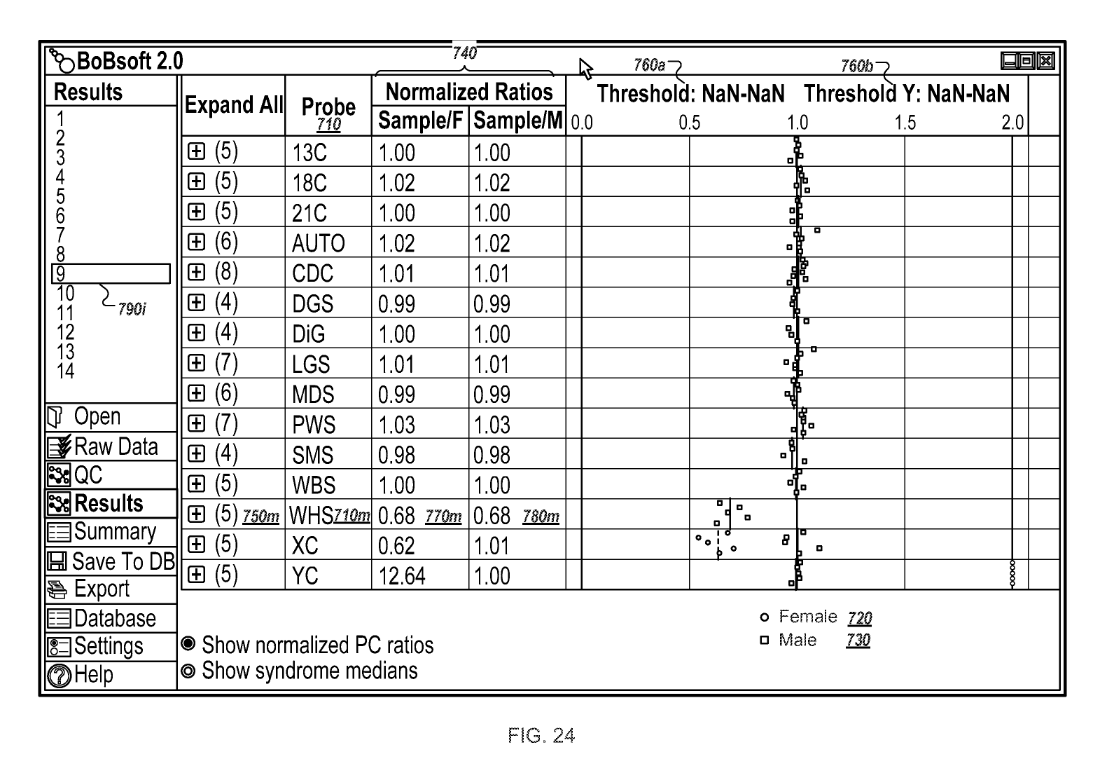

FIG. 24 shows the assay results analyzed, for example, according to the exemplary method 200 described above in relation to FIG. 2. The fluorescence data analyzed according to at least a portion of the features described within the method 200 was the same data analyzed by the ratio method as depicted in FIG. 23, but shows reduced noise, allowing for a more accurate determination of the presence of a chromosomal abnormality in the sample.

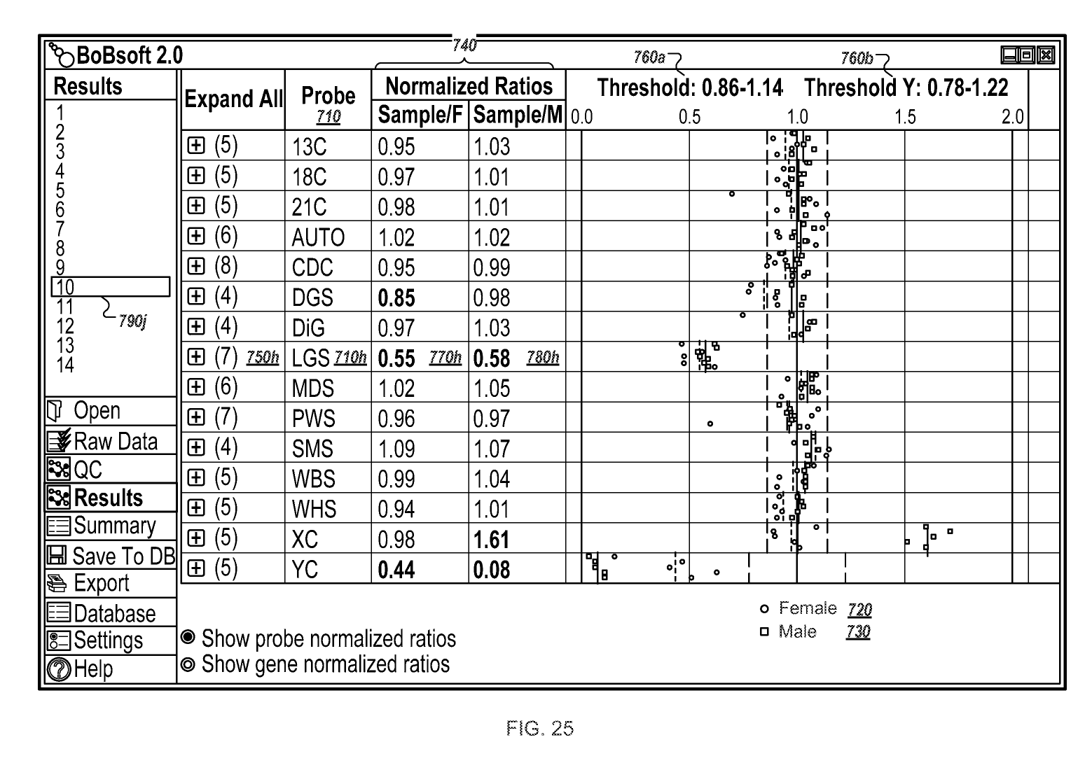

FIG. 25 shows assay results calculated by the ratio algorithm for Sample 10 (Langer-Giedion Syndrome) 790j as described for FIG. 7. Row 8 750h, which depicts the data obtained using probes to the microdeletion in chromosome 4 associated with Langer-Giedion Syndrome 710h, shows normalized values of 0.55 (Sample/F 770h) and 0.58 (Sample/M 780h) outside of the threshold range, indicating that this sample contains the microdeletion.

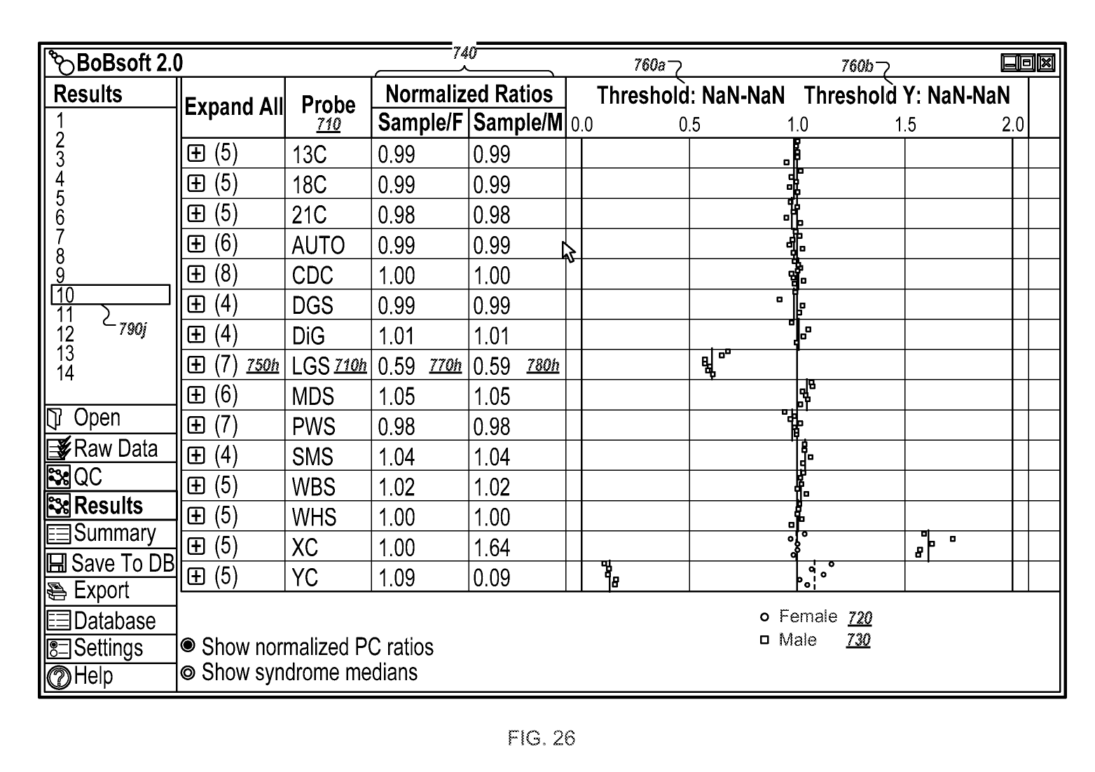

FIG. 26 shows the assay results analyzed, for example, according to the exemplary method 200 described above in relation to FIG. 2. The fluorescence data analyzed according to at least a portion of the features described within the method 200 was the same data analyzed by the ratio method as depicted in FIG. 25, but shows reduced noise, allowing for a more accurate determination of the presence of a chromosomal abnormality in the sample.

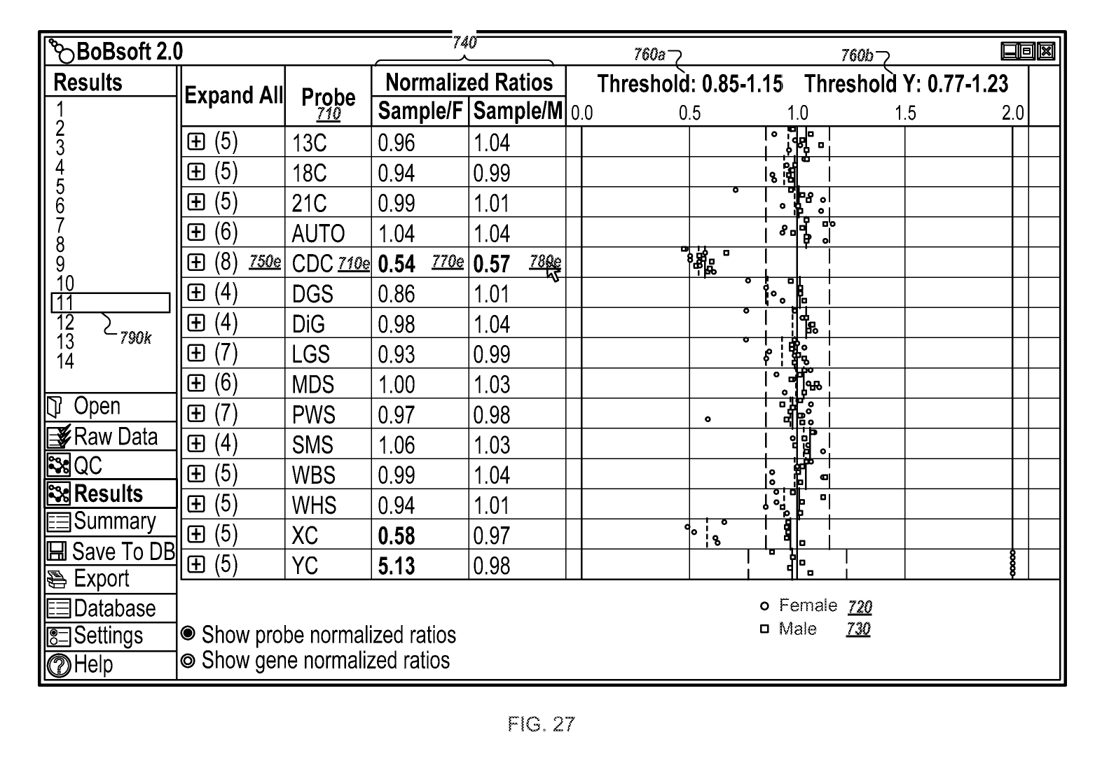

FIG. 27 shows assay results calculated by the ratio algorithm for Sample 11 (Cri-du-chat Syndrome) 790k as described for FIG. 7. Row 5 750e, which depicts the data obtained using probes to the microdeletion in chromosome 5 associated with Cri-du-chat Syndrome 710e, shows normalized values of 0.54 (Sample/F 770e) and 0.57 (Sample/M 780e) outside of the threshold range, indicating that this sample contains the microdeletion.

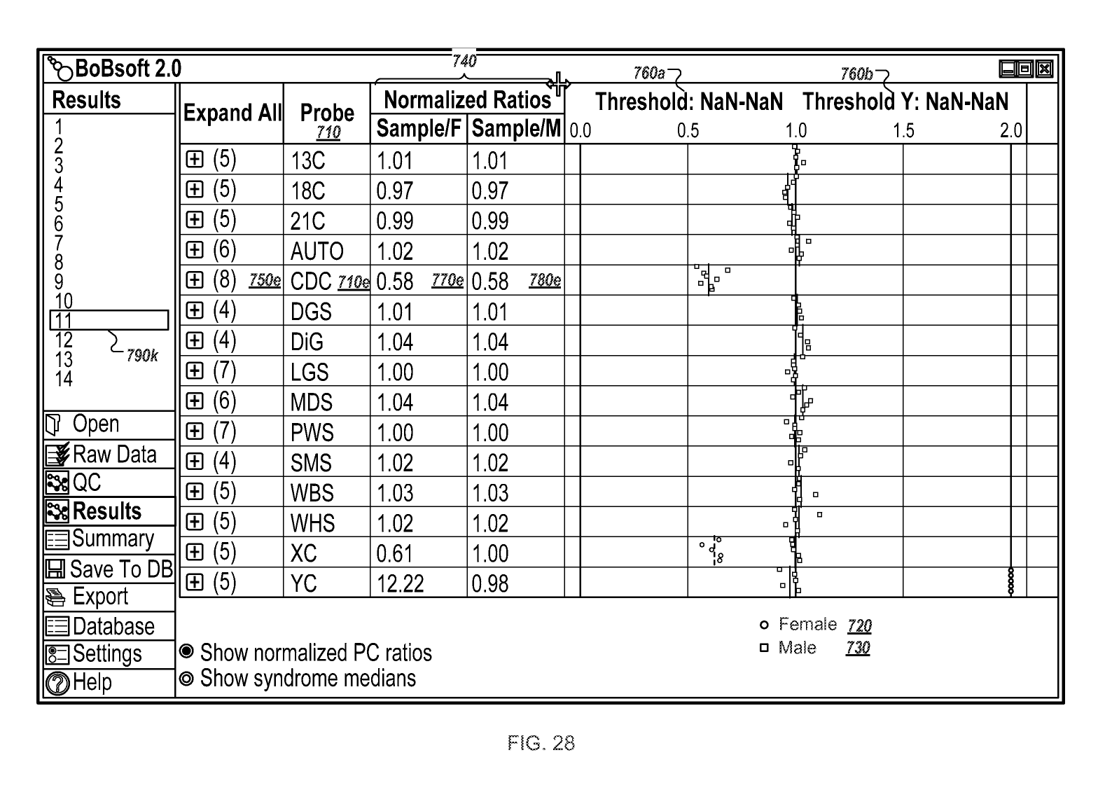

FIG. 28 shows the assay results analyzed, for example, according to the exemplary method 200 described above in relation to FIG. 2. The fluorescence data analyzed according to at least a portion of the features described within the method 200 was the same data analyzed by the ratio method as depicted in FIG. 27, but shows reduced noise, allowing for a more accurate determination of the presence of a chromosomal abnormality in the sample.

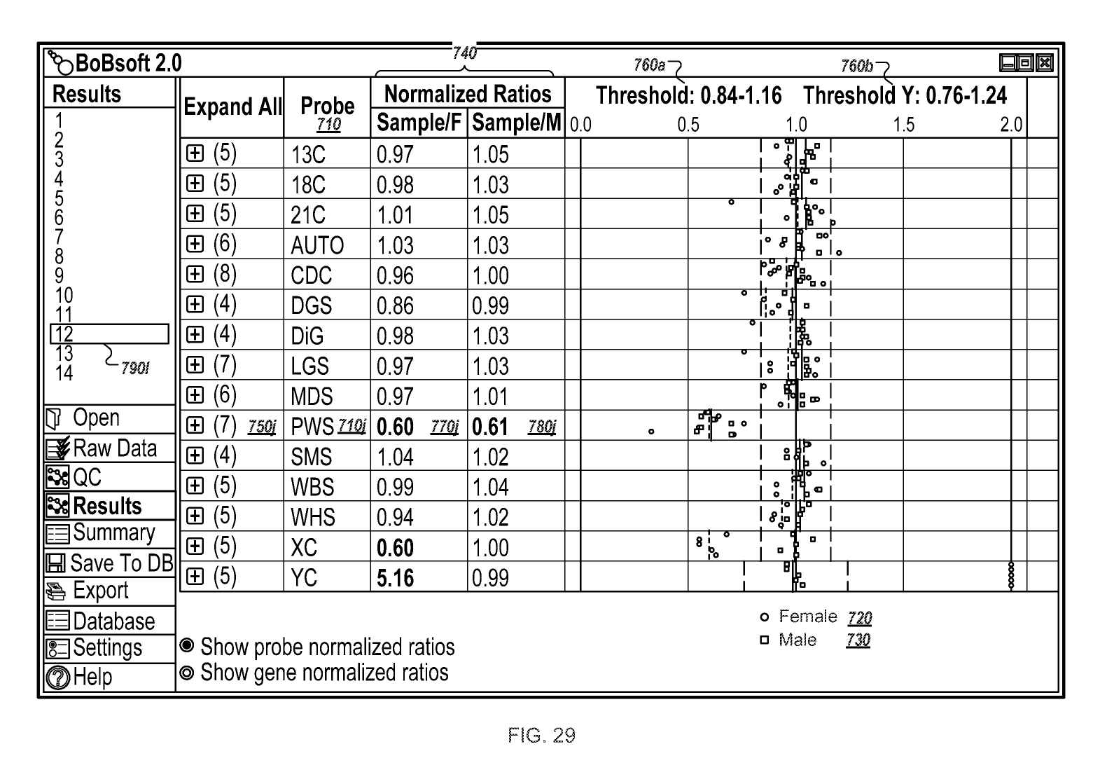

FIG. 29 shows assay results calculated by the ratio algorithm for Sample 12 (Prader-Willi Syndrome) 7901 as described for FIG. 7. Row 10 750j, which depicts the data obtained using probes to the microdeletion in chromosome 15 associated with Prader-Willi Syndrome 710j, shows normalized values of 0.60 (Sample/F 770j) and 0.61 (Sample/M 780j) outside of the threshold range, indicating that this sample contains the microdeletion.

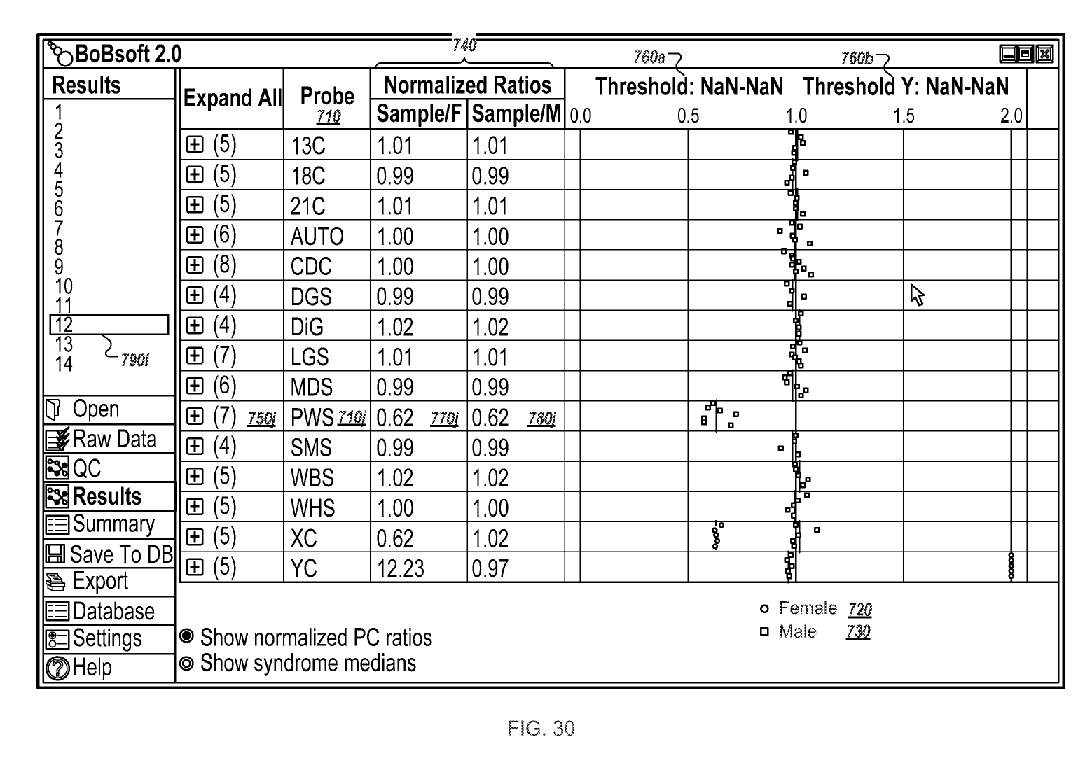

FIG. 30 shows the assay results analyzed, for example, according to the exemplary method 200 described above in relation to FIG. 2. The fluorescence data analyzed according to at least a portion of the features described within the method 200 was the same data analyzed by the ratio method as depicted in FIG. 29, but shows reduced noise, allowing for a more accurate determination of the presence of a chromosomal abnormality in the sample.

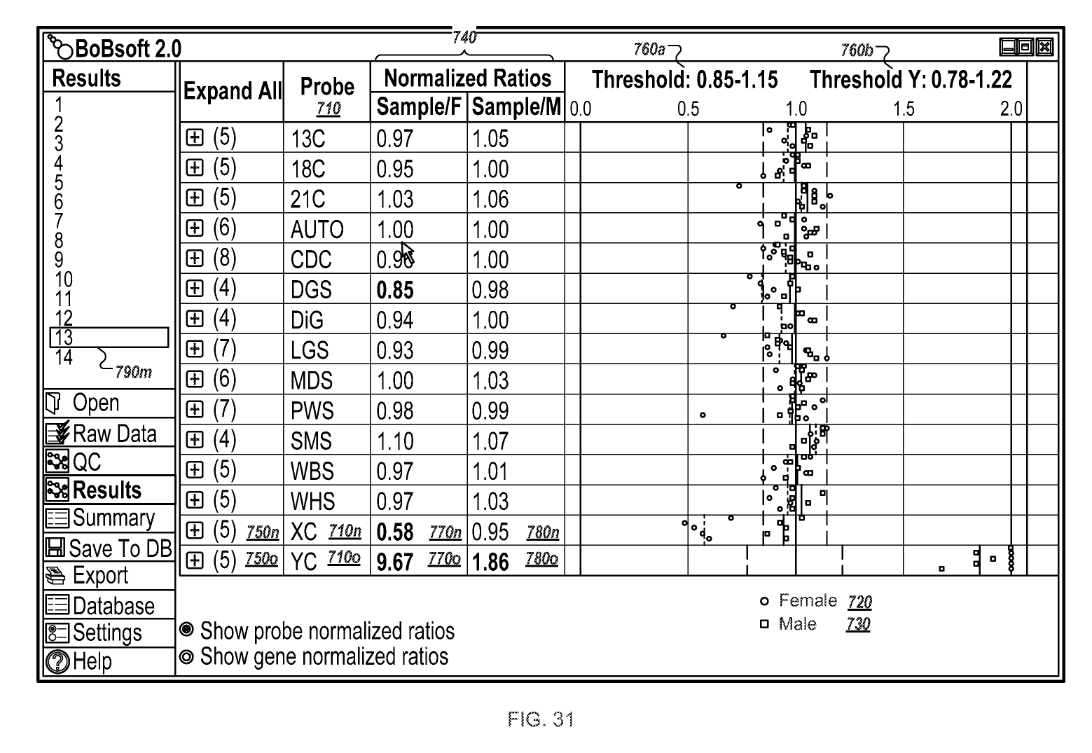

FIG. 31 shows assay results calculated by the ratio algorithm for Sample 13 (Disomy Y; XYY) 790m as described for FIG. 7. Row 14 750n, which depicts the data obtained using probes to the X chromosome 710n, shows normalized values of 0.58 (Sample/F 770n) outside of the threshold range. In addition, Row 15 750o, which depicts the data obtained using probes to the Y chromosome 710o, shows normalized values of 9.67 (Sample/F 770o) and 1.86 (Sample/M 780o) outside of the threshold range, indicating that this sample contains Disomy Y.

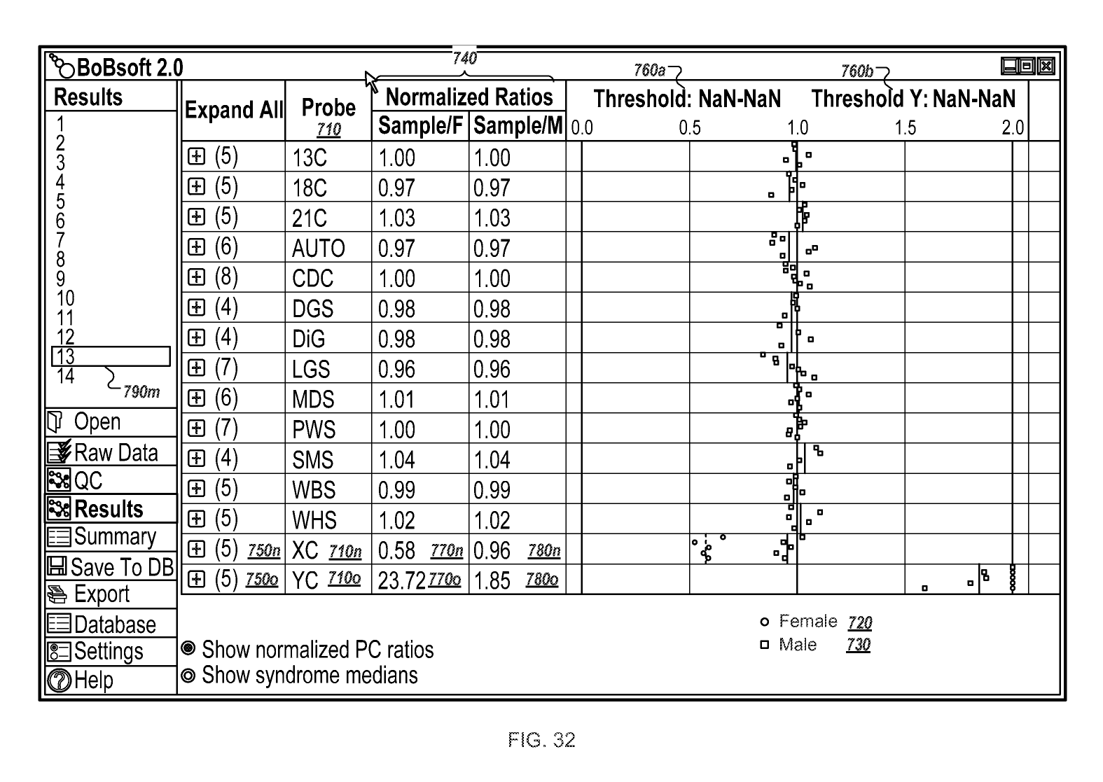

FIG. 32 shows the assay results analyzed, for example, according to the exemplary method 200 described above in relation to FIG. 2. The fluorescence data analyzed according to at least a portion of the features described within the method 200 was the same data analyzed by the ratio method as depicted in FIG. 31, but shows reduced noise, allowing for a more accurate determination of the presence of a chromosomal abnormality in the sample.

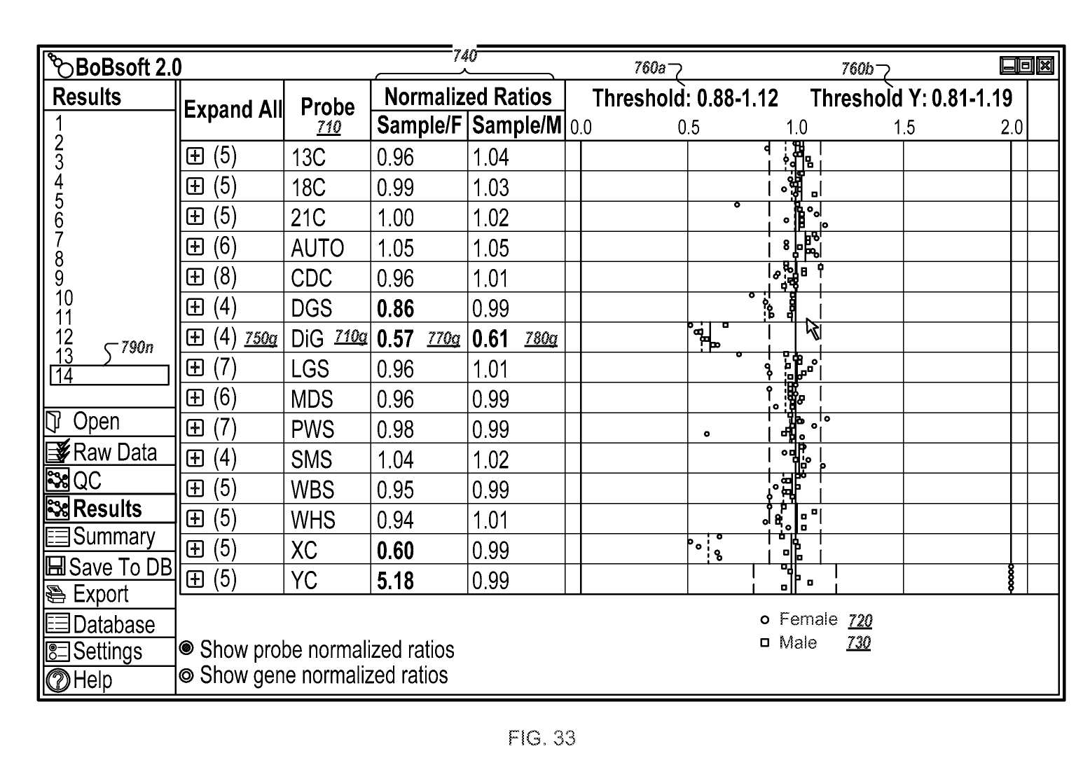

FIG. 33 shows assay results calculated by the ratio algorithm for Sample 14 (DiGeorge 10p14) 790n as described for FIG. 7. Row 7 750g, which depicts the data obtained using probes to the microdeletion in chromosome 10 associated with Di George Syndrome (10p14) 710g, shows normalized values of 0.57 (Sample/F 770g) and 0.61 (Sample/M 780g) outside of the threshold range, indicating that this sample contains the microdeletion.

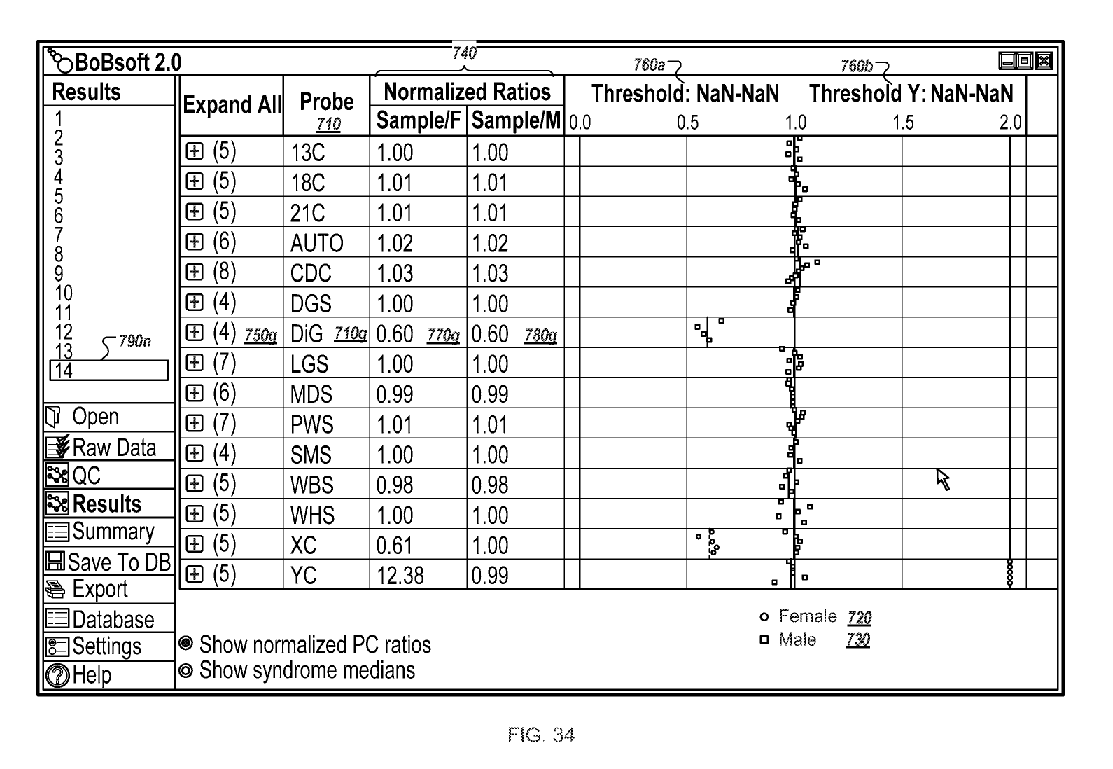

FIG. 34 shows the assay results analyzed, for example, according to the exemplary method 200 described above in relation to FIG. 2. The fluorescence data analyzed according to at least a portion of the features described within the method 200 was the same data analyzed by the ratio method as depicted in FIG. 33, but shows reduced noise, allowing for a more accurate determination of the presence of a chromosomal abnormality in the sample.

While systems and methods for detection of chromosomal gains and losses have been particularly shown and described with reference to specific preferred embodiments, it should be understood by those skilled in the art that various changes in form and detail may be made therein without departing from the spirit and scope of the invention as defined by the appended claims.

1. A method for automated analysis of data from an encoded bead multiplex assay for detection of chromosomal aneuploidies and/or microdeletions, the method comprising the steps of:
(a) providing or receiving a set of background-subtracted data corresponding to an encoded bead multiplex assay for a plurality of patient samples run in parallel, wherein the data represents signals detected from beads corresponding to each of a plurality of chromosomal targets for each of a first through n^{th} patient sample, wherein the chromosomal targets are selected for the detection of chromosomal aneuploidies and/or microdeletions;
(b) following step (a), normalizing, by a processor of a computing device, the background-subtracted data from step (a) for each of the first through n^{th} patient samples using a median of signals detected from beads for the corresponding first through n^{th} patient sample, thereby producing normalized data;
(c) following step (b), for the normalized data corresponding to each chromosomal target, determining, by the processor, a principal component, and
for each principal component, determining, by the processor, a corresponding parallel component and an orthogonal component using the normalized data from step (b);
(d) following step (c), for each of the first through n^{th} patient sample and for each chromosomal target, identifying a deviation from a threshold value indicative of a signal from a normal sample using the corresponding parallel components determined in step (c); and
(e) following step (d), for each of the first through n^{th} patient sample and for each chromosomal target, identifying at least one quality parameter indicative of sample preparation quality using the corresponding orthogonal components determined in step (c).

2. The method of claim 1, further comprising the step of:
(f) determining one or more chromosomal aneuploidies and/or microdeletions for any one or more of the first through n^{th} patient samples on the basis of the deviations determined in step (d) and the quality parameters determined in step (e).

3. The method of claim 1, wherein the background-subtracted data in step (a) represents signals detected from 2 to 10 encoded bead types corresponding to each of the chromosomal targets.

4. (canceled)

5. The method of claim 1, wherein the background-subtracted data in step (a) represents signals detected from encoded beads corresponding to each of at least 3 chromosomal targets for the detection of chromosomal aneuploidies and/or microdeletions.

6.-7. (canceled)

8. The method of claim 1, wherein the background-subtracted data in step (a) represents signals detected from beads for each of from at least 5 patient samples.

9.-10. (canceled)

11. The method of claim 1, wherein the plurality of samples run in parallel are run on a single microplate for signal detection.

12. The method of claim 1, wherein the chromosomal targets are selected for detection of one or more chromosomal aneuploidies, wherein the one or more chromosomal aneuploidies comprise at least one trisomy.

13. The method of claim 1, wherein the chromosomal targets are selected for detection of one or more microdelections each having length in the range of from 20 to 300 kilobases.

14. The method of claim 1, wherein step (b) comprises normalizing the background-subtracted data from step (a) for each of the first through n^{th} patient samples using a median of signals detected from beads for the corresponding first through n^{th} patient sample and using a median of medians of signals from the plurality of patient samples run in parallel, thereby producing the normalized data.

15. The method of claim 1, wherein step (b) comprises normalizing the data for a first through m^{th} bead type of the first through n^{th} patient sample using a median of signals detected from the corresponding first through m^{th} bead type of the plurality of patient samples run in parallel.

16. The method of claim 1, wherein step (b) comprises normalizing the background-subtracted data from step (a) for each of the first through n^{th} patient samples using a normalization factor that eliminates bead-to-bead variation, thereby producing double-distilled normalized data.

17. The method of claim 1, wherein step (c) comprises determining the corresponding parallel component and the orthogonal component using the normalized data for the corresponding chromosomal target for the plurality of patient samples.

18.-19. (canceled)

20. The method of claim 1, wherein the at least one quality parameter identified in step (e) indicates whether a deviation identified in step (d) is suspicious (false positive).

21. The method of claim 1, wherein the at least one quality parameter for a given patient sample and a given chromosomal target is identified in step (e) using deviations identified in step (d) for other chromosomal targets for the given patient sample, such that multiple anomalies are identified as indicative of poor sample preparation.

22. The method of claim 1, wherein the chromosomal targets are selected for the detection of chromosomal aneuploidies and/or microdeletions comprising at least one member selected from the group consisting of Williams-Beuren Syndrome, Smith-Magenis Syndrome, Angleman Syndrome, Down Syndrome (Trisomy 21), Edwards Syndrome (Trisomy 18 & X), Patau Syndrome, DiGeorge Syndrome (Velocardio Facial Syndrome), Mille-Dieker Syndrome, Solf-Hirschorn Syndrome, Langer-Giedion Syndrome, Cri-du-chat Syndrome, Prader-Willi Syndrome, 47 XYY Syndrome, and DiGeorge II Syndrome (10p14 microdeletion).

23. The method of claim 1, further comprising determining a gender for each of the first through n^{th} patient samples by determining a principal component and corresponding parallel component for a Y chromosome target and identifying a deviation from a threshold value indicative of a signal from a male or female sample using the corresponding parallel component.

24. An apparatus for automated analysis of data from an encoded bead multiplex assay for detection of chromosomal aneuploidies and/or microdeletions, the apparatus comprising:
a memory for storing a code defining a set of instructions; and
a processor for executing the set of instructions, wherein the instructions, when executed, cause the processor to:
(a) provide a set of background-subtracted data corresponding to an encoded bead multiplex assay for a plurality of patient samples run in parallel, wherein the data represents signals detected from beads corresponding to each of a plurality of chromosomal targets for each of a first through n^{th} patient sample, wherein the chromosomal targets are selected for the detection of chromosomal aneuploidies and/or microdeletions;
(b) following step (a), normalize the background-subtracted data from step (a) for each of the first through n^{th} patient samples using a median of signals detected from beads for the corresponding first through n^{th} patient sample, thereby producing normalized data;
(c) following step (b), for the normalized data corresponding to each chromosomal target, determine a principal component and for each principal component, determine a corresponding parallel component and an orthogonal component using the normalized data from step (b);
(d) following step (c), for each of the first through n^{th} patient sample and for each chromosomal target, identify a deviation from a threshold value indicative of a signal from a normal sample using the corresponding parallel components determined in step (c); and
(e) following step (d), for each of the first through n^{th} patient sample and for each chromosomal target, identify at least one quality parameter indicative of sample preparation quality using the corresponding orthogonal components determined in step (c).

25. A method comprising:
accessing, by a processor of a computing device, a set of background-subtracted data corresponding to an encoded bead multiplex assay, wherein
the set of background-subtracted data comprises data related to a plurality of patient samples,
the background-subtracted data represents signals detected from beads corresponding to each chromosomal target of a plurality of chromosomal targets for each patient sample of the plurality of patient samples, and
each chromosomal target of the plurality of chromosomal targets is identified for the detection of at least one of chromosomal aneuploidies and microdeletions;
for each patient sample of the plurality of patient samples,
normalizing, by the processor, the background-subtracted data of the respective patient sample to determine normalized data, wherein normalizing comprises determining a median of signals detected from beads of the respective patient sample,
for each chromosomal target of the plurality of chromosomal targets,
determining, by the processor, a respective principal component of the respective normalized data, and
determining, by the processor, a parallel component of the respective principal component; and
for at least a first chromosomal target of the plurality of chromosomal targets, and for at least a first patient sample of the plurality of patient samples, using the respective parallel component, identifying, by the processor, one or more signal values within the respective normalized data deviating by at least a threshold value from a normal sample value, wherein the one or more signal values represent potential genetic abnormality.

26. The method of claim 25, further comprising, for each chromosomal target of the plurality of chromosomal targets, for each patient sample of the plurality of patient samples:
determining an orthogonal component of the respective principal component; and
identifying, based at least in part upon the orthogonal component, one or more quality parameters indicative of sample preparation quality.

27. The method of claim 26, further comprising, for at least the first chromosomal target of the plurality of chromosomal targets, and for at least the first patient sample of the plurality of patient samples, identifying a suspected bad sample, wherein the suspected bad sample is identified based in part upon at least one of the one or more quality parameters indicative of sample preparation quality.

28. (canceled)

29. The method of claim 26, further comprising, for at least the first chromosomal target of the plurality of chromosomal targets, and for at least the first patient sample of the plurality of patient samples, confirming genetic abnormality in relation to the one or more signal values within the respective normalized data deviating by at least the threshold value from the normal sample value, wherein confirming genetic abnormality comprises confirming the one or more quality parameters are indicative of good sample preparation quality.

30. The method of claim 25, further comprising, after normalizing the background-subtracted data, renormalizing the background-subtracted data, wherein renormalizing the background-subtracted data comprises determining a median of a first normalized bead signal a for all patients of the plurality of patients, and, for each patient of the plurality of patients, normalizing the respective normalized data using the median of the first normalized bead signal α.

31. The method of claim 25, further comprising, for each patient sample of the plurality of patients samples, determining a gender of the respective patient, wherein determining the gender of the respective patient comprises identifying, using the respective parallel component, a deviation from a threshold value indicative of a signal from one of a male sample and a female sample.

32. The method of claim 25, further comprising determining the threshold value, wherein the threshold value is based upon a mean absolute deviation within the normalized data.

33.-34. (canceled)
